(19) United States
(12) Patent Application Publication
(10) Pub. No.: US 2026/0037418 A1
(43) Pub. Date: Feb. 5, 2026

(54) DYNAMICALLY BUILDING TEST ENVIRONMENT BASED ON TEST QUEUE

(71) Applicant: Charter Communications Operating, LLC, St. Louis, MO (US)

(72) Inventor: Jeffrey Carter, Marvin, NC (US)

(21) Appl. No.: 18/791,817

(22) Filed: Aug. 1, 2024

(51) Int. Cl. G06F 11/36; G06F 9/455

(52) U.S. Cl. CPC G06F 11/3698; G06F 9/45558; G06F 11/3688; G06F 2009/45562

(57) ABSTRACT

With a test queue analysis module (TQAM), access a test queue to identify a first test pertaining to at least one of hardware, software, and firmware. With the TQAM, determine that it would be inappropriate to run the first test on an existing test environment. With the TQAM, responsive to the determination of inappropriateness, check with a hardware resource mapping module to determine that resources are available to build a new test environment for the first test. With the TQAM, responsive to the determination that the resources are available, assign a unique test environment ID and cause the hardware resource mapping module to commence instantiation of the new test environment for the first test.

### FIELD OF THE INVENTION

The present invention relates generally to the electrical, electronic and computer arts, and, more particularly, to electronic devices, networking, and network management.

### BACKGROUND OF THE INVENTION

In the field of hardware testing, the efficiency and effectiveness of testing procedures greatly influence the time-to-market and product quality. Traditional testing environments often require significant setup time, leading to delays and inefficiencies in the testing process. For example, traditional testing for advanced Wi-Fi devices and the like can be carried out in a laboratory with limited test capacity. Current manual test scheduling and setup techniques may limit effective utilization of laboratory resources and waste the time of human test engineers. For example, a test that takes 20 seconds to execute could take 10-15 minutes or more to set up. Furthermore, test equipment is expensive, and the time when such equipment is idle represents a lost opportunity cost.

Co-assigned US Patent Application Publication 2023-0071504 A1 of Matthew James Wright et al. discloses a multi-client orchestrated automated testing platform; in Wright et al., a method is provided for operating an automated testing platform, which includes, inter alia, providing a testing cloud application running on the automated testing platform.

### SUMMARY OF THE INVENTION

Principles of the invention provide techniques for dynamically building a hardware test environment based on a test queue. In one aspect, an exemplary computer-implemented method includes the operations of with a test queue analysis module, accessing a test queue to identify a first test pertaining to at least one of hardware, software, and firmware; with the test queue analysis module, determining that it would be inappropriate to run the first test on an existing test environment; with the test queue analysis module, responsive to the determination of inappropriateness, checking with a hardware resource mapping module to determine that resources are available to build a new test environment for the first test; and, with the test queue analysis module, responsive to the determination that the resources are available, assigning a unique test environment ID and causing the hardware resource mapping module to commence instantiation of the new test environment for the first test.

In another aspect, an exemplary non-transitory computer readable medium includes computer executable instructions which when executed by a computer cause the computer to perform a method including the steps of: instantiating a test queue analysis module; with the test queue analysis module, accessing a test queue to identify a first test pertaining to at least one of hardware, software, and firmware; with the test queue analysis module, determining that it would be inappropriate to run the first test on an existing test environment; with the test queue analysis module, responsive to the determination of inappropriateness, checking with a hardware resource mapping module to determine that resources are available to build a new test environment for the first test; and with the test queue analysis module, responsive to the determination that the resources are available, assigning a unique test environment ID and causing the hardware resource mapping module to commence instantiation of the new test environment for the first test.

In still another aspect, an exemplary apparatus includes a memory; and at least one processor, coupled to the memory, and operative to: instantiate a test queue analysis module; with the test queue analysis module, access a test queue to identify a first test pertaining to at least one of hardware, software, and firmware; with the test queue analysis module, determine that it would be inappropriate to run the first test on an existing test environment; with the test queue analysis module, responsive to the determination of inappropriateness, check with a hardware resource mapping module to determine that resources are available to build a new test environment for the first test; and with the test queue analysis module, responsive to the determination that the resources are available, assign a unique test environment ID and causing the hardware resource mapping module to commence instantiation of the new test environment for the first test.

In a further aspect, an exemplary system includes a test queue; a hardware resource mapping module; and a test queue analysis module coupled to the test queue and the hardware resource mapping module and configured to: access the test queue to identify a first test pertaining to at least one of hardware, software, and firmware; determine that it would be inappropriate to run the first test on an existing test environment; responsive to the determination of inappropriateness, check with the hardware resource mapping module to determine that resources are available to build a new test environment for the first test; and responsive to the determination that the resources are available, assign a unique test environment ID and cause the hardware resource mapping module to commence instantiation of the new test environment for the first test.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a non-transitory machine-readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus including a memory and at least one processor that is coupled to the memory and operative to perform, or facilitate performance of, exemplary method steps (or a system wherein one or more such apparatuses are networked together, optionally with one or more other components). Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein.

Aspects of the present invention can provide substantial beneficial technical effects. For example, one or more embodiments of the invention achieve one or more of:
efficient and effective testing procedures;
dynamic building of a hardware test environment based on a queue of tests, offering a significant advancement in the field of hardware testing;
streamlining the test setup process, reducing delays and optimizing resource usage;
reduced test setup time: setup time is minimized by automatically and dynamically building test environments, and monitoring availability of existing environments for reuse;
enhanced testing efficiency: tests can be executed immediately upon their scheduled time, reducing or eliminating delays;
optimized resource utilization: hardware resources are efficiently allocated, maximizing their usage;
parallel testing: multiple tests can run concurrently, speeding up the testing process;
support for the simulation and redesign of network configurations and components to address failures in the field;
support for test and redesign of hardware, software, firmware and the like;
preventing the deployment of products and features that have high failure rates;
optimized test capacity and test throughput;
improving the technological process of operating a communications network by detecting issues before deployment and/or fixing deployed equipment that is problematic; and/or
improving the technological process of operating a communications network by determining a percentage likelihood of reliability (e.g., 96%, 99%, 99.99%) to support deployment/replacement decisions (as compared to prior art “GO/NO GO” decisioning).

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of an exemplary embodiment of a system, within which one or more aspects of the invention can be implemented;

FIG. 2 is a functional block diagram illustrating an exemplary hybrid fiber-coaxial (HFC) divisional network configuration, useful within the system of FIG. 1;

FIG. 3 is a functional block diagram illustrating one exemplary HFC cable network head-end configuration, useful within the system of FIG. 1;

FIG. 4 is a functional block diagram illustrating one exemplary local service node configuration useful within the system of FIG. 1;

FIG. 5 is a functional block diagram of a premises network, including an exemplary centralized customer premises equipment (CPE) unit, interfacing with a head end such as that of FIG. 3;

FIG. 6 is a functional block diagram of an exemplary centralized CPE unit, useful within the system of FIG. 1;

FIG. 7 is a block diagram of a computer system useful in connection with one or more aspects of the invention;

FIG. 8 is a functional block diagram illustrating an exemplary FTTH system, which is one exemplary system within which one or more embodiments could be employed;

FIG. 9 is a functional block diagram of an exemplary centralized S-ONU CPE unit interfacing with the system of FIG. 8;

FIG. 10 is a block diagram that also depicts an exemplary workflow for dynamically constructing a hardware test environment, in accordance with an exemplary embodiment;

FIG. 11 is a flowchart for a method to build test queues, in accordance with an exemplary embodiment; and

FIG. 12 is a flowchart for a method for analyzing and orchestrating tests in the test queue, in accordance with an exemplary embodiment.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

One or more embodiments can be employed for the testing of many different types of networks. One non-limiting example is a hybrid fiber-coaxial (HFC) network; other non-limiting examples include fiber optic networks such as fiber to the home (FTTH) networks. HFC and FTTH networks and the like can, in some instances, deliver video programs as well as data; the skilled artisan will understand from the context whether a “program” refers to a video program or a computer program.

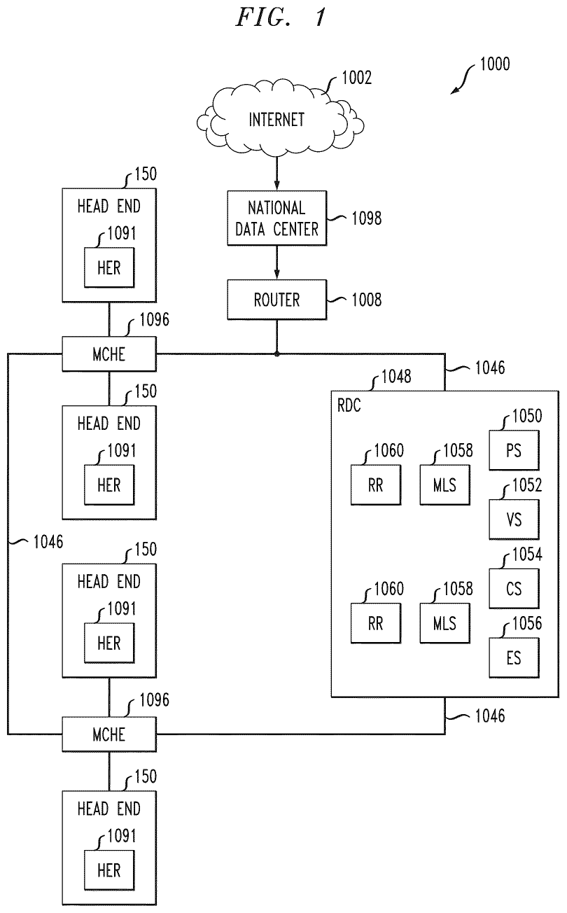

Thus, purely by way of example and not limitation, a description will be provided of a cable multi-service operator (MSO) providing data services as well as entertainment services, as an example environment in which aspects of the invention could be employed, it being understood that aspects of the invention could be employed in many different network environments. FIG. 1 shows an exemplary system 1000, according to an aspect of the invention. System 1000 includes a regional data center (RDC) 1048 coupled to several Market Center Head Ends (MCHEs) 1096; each MCHE 1096 is in turn coupled to one or more divisions, represented by division head ends 150. In a non-limiting example, the MCHEs are coupled to the RDC 1048 via a network of switches and routers. One suitable example of network 1046 is a dense wavelength division multiplex (DWDM) network. The MCHEs can be employed, for example, for large metropolitan area(s). In addition, the MCHE is connected to localized HEs 150 via high-speed routers 1091 (“HER”=head end router) and a suitable network, which could, for example, also utilize DWDM technology. Elements 1048, 1096 on network 1046 may be operated, for example, by or on behalf of a cable MSO, and may be interconnected with a global system of interconnected computer networks that use the standardized Internet Protocol Suite (TCP/IP) (transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, California, USA.

Head end routers 1091 are omitted from figures below to avoid clutter, and not all switches, routers, etc. associated with network 1046 are shown, also to avoid clutter.

RDC 1048 may include one or more provisioning servers (PS) 1050, one or more Video Servers (VS) 1052, one or more content servers (CS) 1054, and one or more e-mail servers (ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head ends (local and/or market center) and/or regional data centers. For example, such an NDC might include one or more VOD servers; switched digital video (SDV) functionality; gateways to obtain content (e.g., program content) from various sources including cable feeds and/or satellite; and so on.

In some cases, there may be more than one national data center 1098 (e.g., two) to provide redundancy. There can be multiple regional data centers 1048. In some cases, MCHEs could be omitted and the local head ends 150 coupled directly to the RDC 1048.

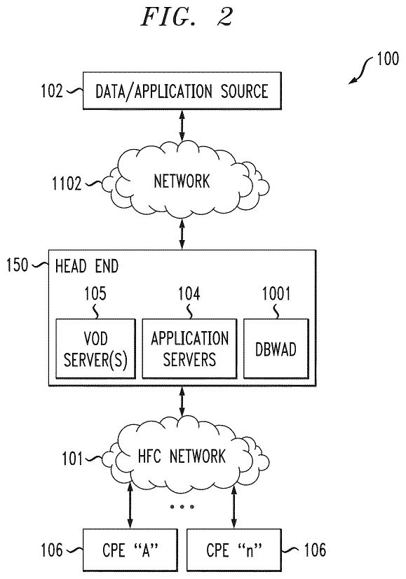

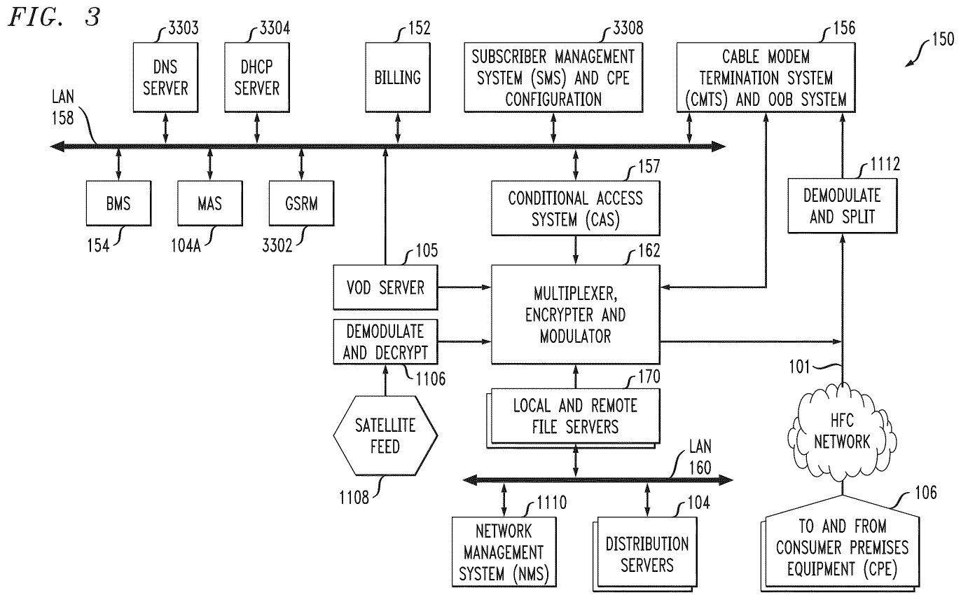

FIG. 2 is a functional block diagram illustrating an exemplary content-based (e.g., hybrid fiber-coaxial (HFC)) divisional network configuration, useful within the system of FIG. 1. Sec, for example, US Patent Publication 2006/0130107 of Gonder et al., entitled “Method and apparatus for high bandwidth data transmission in content-based networks,” the complete disclosure of which is expressly incorporated by reference herein in its entirety for all purposes. The various components of the network 100 include (i) one or more data and application origination points 102; (ii) one or more application distribution servers 104; (iii) one or more video-on-demand (VOD) servers 105, and (v) consumer premises equipment or customer premises equipment (CPE). The distribution server(s) 104, VOD servers 105 and CPE(s) 106 are connected via a bearer (e.g., HFC) network 101. Servers 104, 105 can be located in head end 150. A simple architecture is shown in FIG. 2 for illustrative brevity, although it will be recognized that comparable architectures with multiple origination points, distribution servers, VOD servers, and/or CPE devices (as well as different network topologies) may be utilized consistent with embodiments of the invention. For example, the head-end architecture of FIG. 3 (described in greater detail below) may be used.

It should be noted that the exemplary CPE 106 is an integrated solution including a cable modem (e.g., DOCSIS) and one or more wireless routers. Other embodiments could employ a two-box solution; i.e., separate cable modem and routers suitably interconnected, which nevertheless, when interconnected, can provide equivalent functionality. Furthermore, FTTH networks can employ Service ONUs (S-ONUs; ONU=optical network unit) as CPE, as discussed elsewhere herein.

The data/application origination point 102 comprises any medium that allows data and/or applications (such as a VOD-based or “Watch TV” application) to be transferred to a distribution server 104, for example, over network 1102. This can include for example a third-party data source, application vendor website, compact disk read-only memory (CD-ROM), external network interface, mass storage device (e.g., Redundant Arrays of Inexpensive Disks (RAID) system), etc. Such transference may be automatic, initiated upon the occurrence of one or more specified events (such as the receipt of a request packet or acknowledgement (ACK)), performed manually, or accomplished in any number of other modes readily recognized by those of ordinary skill, given the teachings herein. For example, in one or more embodiments, network 1102 may correspond to network 1046 of FIG. 1, and the data and application origination point may be, for example, within NDC 1098, RDC 1048, or on the Internet 1002. Head end 150, HFC network 101, and CPEs 106 thus represent the divisions which were represented by division head ends 150 in FIG. 1.

The application distribution server 104 comprises a computer system where such applications can enter the network system. Distribution servers per se are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

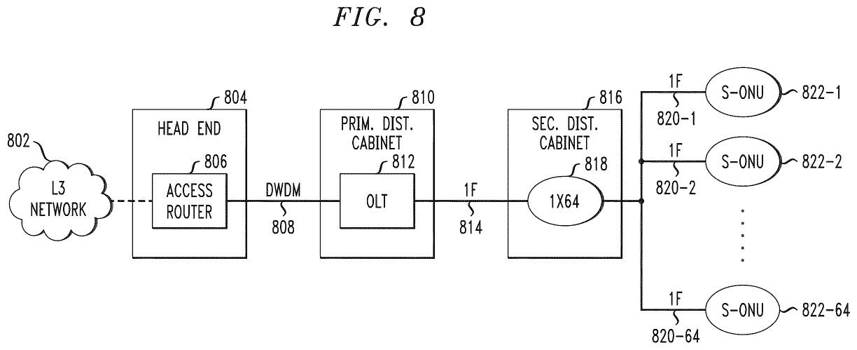

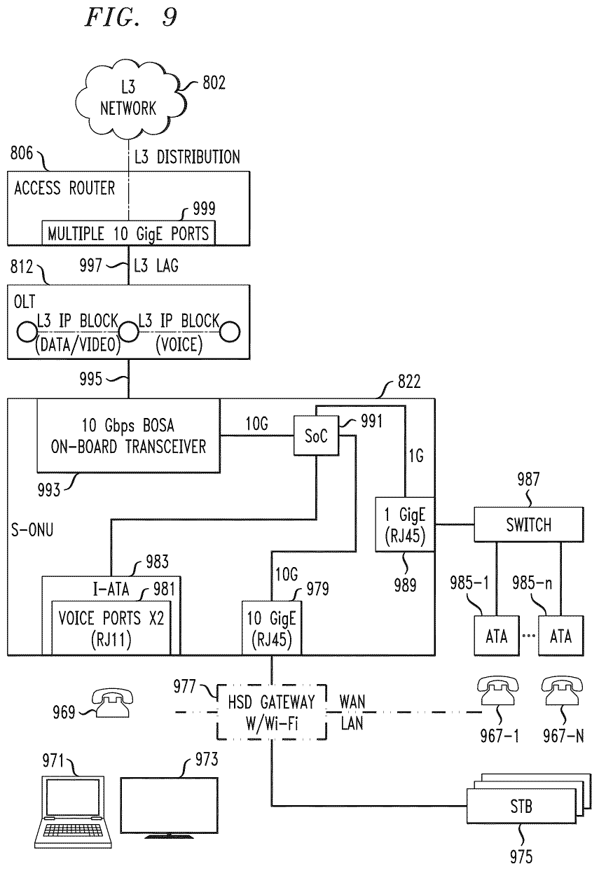

The CPE 106 includes any equipment in the “customers' premises” (or other appropriate locations) that can be accessed by the relevant upstream network components. Non-limiting examples of relevant upstream network components, in the context of the HFC network, include a distribution server 104 or a cable modem termination system 156 (discussed below with regard to FIG. 3). The skilled artisan will be familiar with other relevant upstream network components for other kinds of networks (e.g., FTTH) as discussed herein. Non-limiting examples of CPE are set-top boxes, high-speed cable modems, and Advanced Wireless Gateways (AWGs) for providing high bandwidth Internet access in premises such as homes and businesses. Reference is also made to the discussion of an exemplary FTTH network in connection with FIGS. 8 and 9.

Also included (for example, in head end 150) is a dynamic bandwidth allocation device (DBWAD) 1001 such as a global session resource manager, which is itself a non-limiting example of a session resource manager.

FIG. 3 is a functional block diagram illustrating one exemplary HFC cable network head-end configuration, useful within the system of FIG. 1. As shown in FIG. 3, the head-end architecture 150 comprises typical head-end components and services including billing module 152, subscriber management system (SMS) and CPE configuration management module 3308, cable-modem termination system (CMTS) and out-of-band (OOB) system 156, as well as LAN(s) 158, 160 placing the various components in data communication with one another. In one or more embodiments, there are multiple CMTSs. Each may be coupled to an HER 1091, for example. Sec, e.g., FIGS. 1 and 2 of co-assigned U.S. Pat. No. 7,792,963 of inventors Gould and Danforth, entitled METHOD TO BLOCK UNAUTHORIZED NETWORK TRAFFIC IN A CABLE DATA NETWORK, the complete disclosure of which is expressly incorporated herein by reference in its entirety for all purposes.

It will be appreciated that while a bar or bus LAN topology is illustrated, any number of other arrangements (e.g., ring, star, etc.) may be used consistent with the invention. It will also be appreciated that the head-end configuration depicted in FIG. 3 is high-level, conceptual architecture and that each multi-service operator (MSO) may have multiple head-ends deployed using custom architectures.

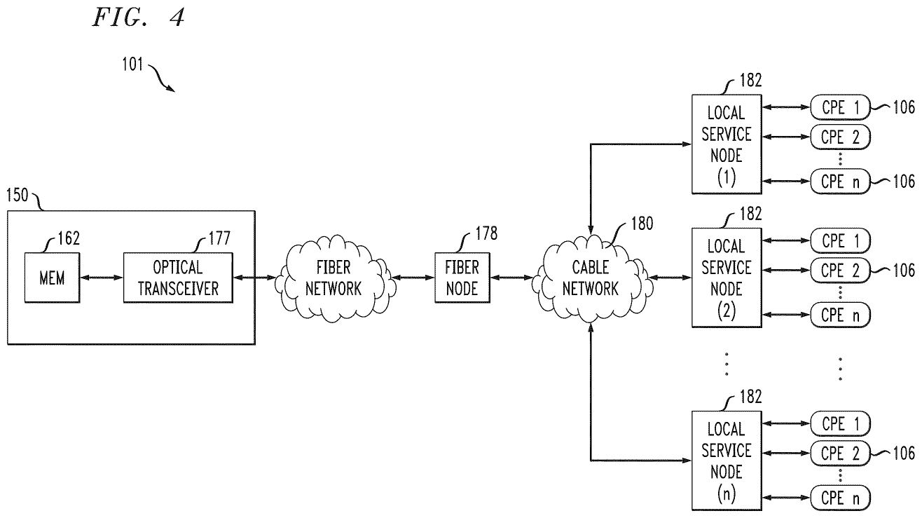

The architecture 150 of FIG. 3 further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 158, although other architectures may be employed (such as for example where the VOD servers are associated with a core switching device such as an 802.3z Gigabit Ethernet device; or the VOD servers could be coupled to LAN 160). Since information is typically carried across multiple channels, the head-end should be adapted to acquire the information for the carried channels from various sources. Typically, the channels being delivered from the head-end 150 to the CPE 106 (“downstream”) are multiplexed together in the head-end and sent to neighborhood hubs (refer to description of FIG. 4) via a variety of interposed network components.

Content (e.g., audio, video, etc.) is provided in each downstream (in-band) channel associated with the relevant service group. (Note that in the context of data communications, internet data is passed both downstream and upstream.) To communicate with the head-end or intermediary node (e.g., hub server), the CPE 106 may use the out-of-band (OOB) or DOCSIS® (Data Over Cable Service Interface Specification) channels (registered mark of Cable Television Laboratories, Inc., 400 Centennial Parkway Louisville CO 80027, USA) and associated protocols (e.g., DOCSIS 1.x, 2.0. or 3.0). The OpenCable™ Application Platform (OCAP) 1.0, 2.0, 3.0 (and subsequent) specification (Cable Television laboratories Inc.) provides for exemplary networking protocols both downstream and upstream, although the invention is in no way limited to these approaches. All versions of the DOCSIS and OCAP specifications are expressly incorporated herein by reference in their entireties for all purposes.

Furthermore in this regard, DOCSIS is an international telecommunications standard that permits the addition of high-speed data transfer to an existing cable TV (CATV) system. It is employed by many cable television operators to provide Internet access (cable Internet) over their existing hybrid fiber-coaxial (HFC) infrastructure. HFC systems using DOCSIS to transmit data are one non-limiting exemplary application context for one or more embodiments. However, one or more embodiments are applicable to a variety of different kinds of networks.

It is also worth noting that the use of DOCSIS Provisioning of EPON (Ethernet over Passive Optical Network) or “DPoE” (Specifications available from CableLabs, Louisville, CO, USA) enables the transmission of high-speed data over PONs using DOCSIS back-office systems and processes.

It will also be recognized that multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

In some instances, material may also be obtained from a satellite feed 1108; such material is demodulated and decrypted in block 1106 and fed to block 162. Conditional access system 157 may be provided for access control purposes. Network management system 1110 may provide appropriate management functions. Note also that signals from MEM 162 and upstream signals from network 101 that have been demodulated and split in block 1112 are fed to CMTS and OOB system 156.

Also included in FIG. 3 are a global session resource manager (GSRM) 3302, a Mystro Application Server 104A, and a business management system 154, all of which are coupled to LAN 158. GSRM 3302 is one specific form of a DBWAD 1001 and is a non-limiting example of a session resource manager.

An ISP DNS server could be located in the head-end as shown at 3303, but it can also be located in a variety of other places. One or more Dynamic Host Configuration Protocol (DHCP) server(s) 3304 can also be located where shown or in different locations.

It should be noted that the exemplary architecture in FIG. 3 shows a traditional location for the CMTS 156 in a head end. As will be appreciated by the skilled artisan, CMTS functionality can be moved down closer to the customers or up to a national or regional data center or can be dispersed into one or more locations.

As shown in FIG. 4, the network 101 of FIGS. 2 and 3 comprises a fiber/coax arrangement wherein the output of the MEM 162 of FIG. 3 is transferred to the optical domain (such as via an optical transceiver 177 at the head-end 150 or further downstream). The optical domain signals are then distributed over a fiber network 179 to a fiber node 178, which further distributes the signals over a distribution network 180 (typically coax) to a plurality of local servicing nodes 182. This provides an effective 1-to-N expansion of the network at the local service end. Each node 182 services a number of CPEs 106. Further reference may be had to US Patent Publication 2007/0217436 of Markley et al., entitled “Methods and apparatus for centralized content and data delivery,” the complete disclosure of which is expressly incorporated herein by reference in its entirety for all purposes. In one or more embodiments, the CPE 106 includes a cable modem, such as a DOCSIS-compliant cable modem (DCCM). Please note that the number n of CPE 106 per node 182 may be different than the number n of nodes 182, and that different nodes may service different numbers n of CPE.

Certain additional aspects of video or other content delivery will now be discussed. It should be understood that embodiments of the invention have broad applicability to a variety of different types of networks. Some embodiments relate to TCP/IP network connectivity for delivery of messages and/or content. Again, delivery of data over a video (or other) content network is but one non-limiting example of a context where one or more embodiments could be implemented. US Patent Publication 2003-0056217 of Paul D. Brooks, entitled “Technique for Effectively Providing Program Material in a Cable Television System,” the complete disclosure of which is expressly incorporated herein by reference for all purposes, describes one exemplary broadcast switched digital architecture, although it will be recognized by those of ordinary skill that other approaches and architectures may be substituted. In a cable television system in accordance with the Brooks invention, program materials are made available to subscribers in a neighborhood on an as-needed basis. Specifically, when a subscriber at a set-top terminal selects a program channel to watch, the selection request is transmitted to a head end of the system. In response to such a request, a controller in the head end determines whether the material of the selected program channel has been made available to the neighborhood. If it has been made available, the controller identifies to the set-top terminal the carrier which is carrying the requested program material, and to which the set-top terminal tunes to obtain the requested program material. Otherwise, the controller assigns an unused carrier to carry the requested program material, and informs the set-top terminal of the identity of the newly assigned carrier. The controller also retires those carriers assigned for the program channels which are no longer watched by the subscribers in the neighborhood. Note that reference is made herein, for brevity, to features of the “Brooks invention”—it should be understood that no inference should be drawn that such features are necessarily present in all claimed embodiments of Brooks. The Brooks invention is directed to a technique for utilizing limited network bandwidth to distribute program materials to subscribers in a community access television (CATV) system. In accordance with the Brooks invention, the CATV system makes available to subscribers selected program channels, as opposed to all of the program channels furnished by the system as in prior art. In the Brooks CATV system, the program channels are provided on an as needed basis, and are selected to serve the subscribers in the same neighborhood requesting those channels.

US Patent Publication 2010-0313236 of Albert Straub, entitled “TECHNIQUES FOR UPGRADING SOFTWARE IN A VIDEO CONTENT NETWORK,” the complete disclosure of which is expressly incorporated herein by reference for all purposes, provides additional details on the aforementioned dynamic bandwidth allocation device 1001.

US Patent Publication 2009-0248794 of William L. Helms, entitled “SYSTEM AND METHOD FOR CONTENT SHARING,” the complete disclosure of which is expressly incorporated herein by reference for all purposes, provides additional details on CPE in the form of a converged premises gateway device. Related aspects are also disclosed in US Patent Publication 2007-0217436 of Markley et al, entitled “METHODS AND APPARATUS FOR CENTRALIZED CONTENT AND DATA DELIVERY,” the complete disclosure of which is expressly incorporated herein by reference for all purposes.

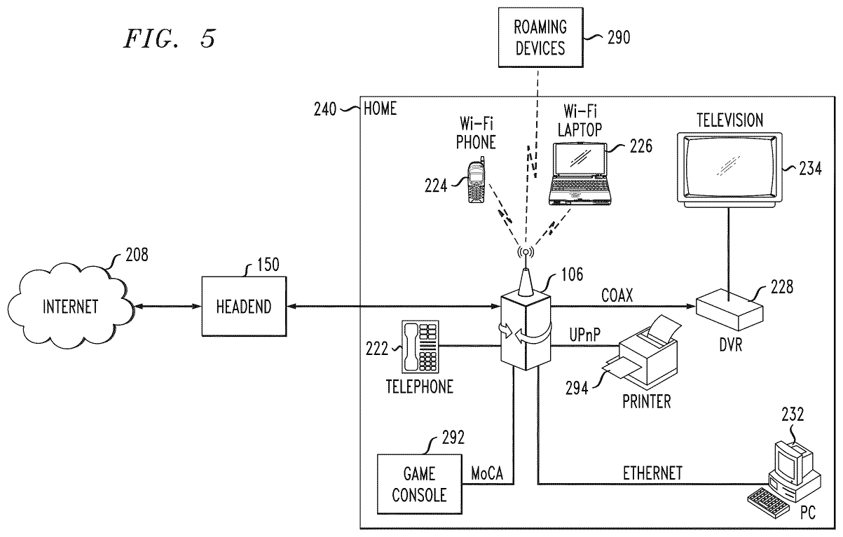

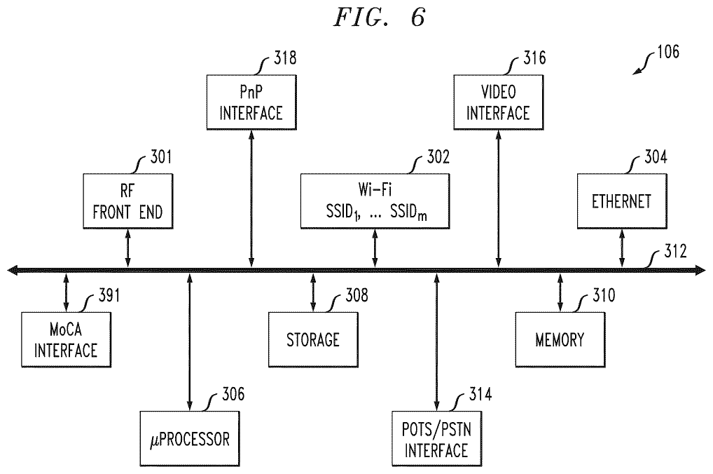

Reference should now be had to FIG. 5, which presents a block diagram of a premises network interfacing with a head end of an MSO or the like, providing Internet access. An exemplary advanced wireless gateway comprising CPE 106 is depicted as well. It is to be emphasized that the specific form of CPE 106 shown in FIGS. 5 and 6 is exemplary and non-limiting, and shows a number of optional features. Many other types of CPE can be employed in one or more embodiments; for example, a cable modem, DSL modem, and the like. The CPE can also be a Service Optical Network Unit (S-ONU) for FTTH deployment—see FIGS. 8 and 9 and accompanying text.

CPE 106 includes an advanced wireless gateway which connects to a head end 150 or other hub of a network, such as a video content network of an MSO or the like. The head end is coupled also to an internet (e.g., the Internet) 208 which is located external to the head end 150, such as via an Internet (IP) backbone or gateway (not shown).

The head end is in the illustrated embodiment coupled to multiple households or other premises, including the exemplary illustrated household 240. In particular, the head end (for example, a cable modem termination system 156 thereof) is coupled via the aforementioned HFC network and local coaxial cable or fiber drop to the premises, including the consumer premises equipment (CPE) 106. The exemplary CPE 106 is in signal communication with any number of different devices including, e.g., a wired telephony unit 222, a Wi-Fi or other wireless-enabled phone 224, a Wi-Fi or other wireless-enabled laptop 226, a session initiation protocol (SIP) phone, an H.323 terminal or gateway, etc. Additionally, the CPE 106 is also coupled to a digital video recorder (DVR) 228 (e.g., over coax), in turn coupled to television 234 via a wired or wireless interface (e.g., cabling, PAN or 802.15 UWB micro-net, etc.). CPE 106 is also in communication with a network (here, an Ethernet network compliant with IEEE Std. 802.3, although any number of other network protocols and topologies could be used) on which is a personal computer (PC) 232.

Other non-limiting exemplary devices that CPE 106 may communicate with include a printer 294; for example, over a universal plug and play (UPnP) interface, and/or a game console 292; for example, over a multimedia over coax alliance (MoCA) interface.

In some instances, CPE 106 is also in signal communication with one or more roaming devices, generally represented by block 290.

A “home LAN” (HLAN) is created in the exemplary embodiment, which may include for example the network formed over the installed coaxial cabling in the premises, the Wi-Fi network, and so forth.

During operation, the CPE 106 exchanges signals with the head end over the interposed coax (and/or other, e.g., fiber) bearer medium. The signals include e.g., Internet traffic (IPv4 or IPv6), digital programming and other digital signaling or content such as digital (packet-based; e.g., VOIP) telephone service. The CPE 106 then exchanges this digital information after demodulation and any decryption (and any demultiplexing) to the particular system(s) to which it is directed or addressed. For example, in one embodiment, a MAC address or IP address can be used as the basis of directing traffic within the client-side environment 240.

Any number of different data flows may occur within the network depicted in FIG. 5. For example, the CPE 106 may exchange digital telephone signals from the head end which are further exchanged with the telephone unit 222, the Wi-Fi phone 224, or one or more roaming devices 290. The digital telephone signals may be IP-based such as Voice-over-IP (VOIP), or may utilize another protocol or transport mechanism. The well-known session initiation protocol (SIP) may be used, for example, in the context of a “SIP phone” for making multi-media calls. The network may also interface with a cellular or other wireless system, such as for example a 3G IMS (IP multimedia subsystem) system, in order to provide multimedia calls between a user or consumer in the household domain 240 (e.g., using a SIP phone or H.323 terminal) and a mobile 3G telephone or personal media device (PMD) user via that user's radio access network (RAN).

The CPE 106 may also exchange Internet traffic (e.g., TCP/IP and other packets) with the head end 150 which is further exchanged with the Wi-Fi laptop 226, the PC 232, one or more roaming devices 290, or other device. CPE 106 may also receive digital programming that is forwarded to the DVR 228 or to the television 234. Programming requests and other control information may be received by the CPE 106 and forwarded to the head end as well for appropriate handling.

FIG. 6 is a block diagram of one exemplary embodiment of the CPE 106 of FIG. 5. The exemplary CPE 106 includes an RF front end 301, Wi-Fi interface 302, video interface 316, “Plug n′ Play” (PnP) interface 318 (for example, a UPnP interface) and Ethernet interface 304, each directly or indirectly coupled to a bus 312. In some cases, Wi-Fi interface 302 comprises a single wireless access point (WAP) running multiple (“m”) service set identifiers (SSIDs). In some cases, multiple SSIDs, which could represent different applications, are served from a common WAP. For example, SSID 1 is for the home user, while SSID 2 may be for a managed security service, SSID 3 may be a managed home networking service, SSID 4 may be a hot spot, and so on. Each of these is on a separate IP subnetwork for security, accounting, and policy reasons. The microprocessor 306, storage unit 308, plain old telephone service (POTS)/public switched telephone network (PSTN) interface 314, and memory unit 310 are also coupled to the exemplary bus 312, as is a suitable MoCA interface 391. The memory unit 310 typically comprises a random-access memory (RAM) and storage unit 308 typically comprises a hard disk drive, an optical drive (e.g., CD-ROM or DVD), NAND flash memory, RAID (redundant array of inexpensive disks) configuration, or some combination thereof.

The illustrated CPE 106 can assume literally any discrete form factor, including those adapted for desktop, floor-standing, or wall-mounted use, or alternatively may be integrated in whole or part (e.g., on a common functional basis) with other devices if desired.

Again, it is to be emphasized that every embodiment need not necessarily have all the elements shown in FIG. 6—as noted, the specific form of CPE 106 shown in FIGS. 5 and 6 is exemplary and non-limiting, and shows a number of optional features. Yet again, many other types of CPE can be employed in one or more embodiments; for example, a cable modem, DSL modem, and the like.

It will be recognized that while a linear or centralized bus architecture is shown as the basis of the exemplary embodiment of FIG. 6, other bus architectures and topologies may be used. For example, a distributed or multi-stage bus architecture may be employed. Similarly, a “fabric” or other mechanism (e.g., crossbar switch, RAPIDIO interface, non-blocking matrix, TDMA or multiplexed system, etc.) may be used as the basis of at least some of the internal bus communications within the device. Furthermore, many if not all of the foregoing functions may be integrated into one or more integrated circuit (IC) devices in the form of an ASIC or “system-on-a-chip” (SoC). Myriad other architectures well known to those in the data processing and computer arts may accordingly be employed.

Yet again, it will also be recognized that the CPE configuration shown is essentially for illustrative purposes, and various other configurations of the CPE 106 are consistent with other embodiments of the invention. For example, the CPE 106 in FIG. 6 may not include all of the elements shown, and/or may include additional elements and interfaces such as for example an interface for the HomePlug A/V standard which transmits digital data over power lines, a PAN (e.g., 802.15), Bluetooth, or other short-range wireless interface for localized data communication, etc.

A suitable number of standard 10/100/1000 Base T Ethernet ports for the purpose of a Home LAN connection are provided in the exemplary device of FIG. 6; however, it will be appreciated that other rates (e.g., Gigabit Ethernet or 10-Gig-E) and local networking protocols (e.g., MoCA, USB, etc.) may be used. These interfaces may be serviced via a WLAN interface, wired RJ-45 ports, or otherwise. The CPE 106 can also include a plurality of RJ-11 ports for telephony interface, as well as a plurality of USB (e.g., USB 2.0) ports, and IEEE-1394 (Firewire) ports. S-video and other signal interfaces may also be provided if desired.

During operation of the CPE 106, software located in the storage unit 308 is run on the microprocessor 306 using the memory unit 310 (e.g., a program memory within or external to the microprocessor). The software controls the operation of the other components of the system, and provides various other functions within the CPE. Other system software/firmware may also be externally reprogrammed, such as using a download and reprogramming of the contents of the flash memory, replacement of files on the storage device or within other non-volatile storage, etc. This allows for remote reprogramming or reconfiguration of the CPE 106 by the MSO or other network agent.

It should be noted that some embodiments provide a cloud-based user interface, wherein CPE 106 accesses a user interface on a server in the cloud, such as in NDC 1098.

The RF front end 301 of the exemplary embodiment comprises a cable modem of the type known in the art. In some cases, the CPE just includes the cable modem and omits the optional features. Content or data normally streamed over the cable modem can be received and distributed by the CPE 106, such as for example packetized video (e.g., IPTV). The digital data exchanged using RF front end 301 includes IP or other packetized protocol traffic that provides access to internet service. As is well known in cable modem technology, such data may be streamed over one or more dedicated QAMs resident on the HFC bearer medium, or even multiplexed or otherwise combined with QAMs allocated for content delivery, etc. The packetized (e.g., IP) traffic received by the CPE 106 may then be exchanged with other digital systems in the local environment 240 (or outside this environment by way of a gateway or portal) via, e.g., the Wi-Fi interface 302, Ethernet interface 304 or plug-and-play (PnP) interface 318.

Additionally, the RF front end 301 modulates, encrypts/multiplexes as required, and transmits digital information for receipt by upstream entities such as the CMTS or a network server. Digital data transmitted via the RF front end 301 may include, for example, MPEG-2 encoded programming data that is forwarded to a television monitor via the video interface 316. Programming data may also be stored on the CPE storage unit 308 for later distribution by way of the video interface 316, or using the Wi-Fi interface 302, Ethernet interface 304, Firewire (IEEE Std. 1394), USB/USB2, or any number of other such options.

Other devices such as portable music players (e.g., MP3 audio players) may be coupled to the CPE 106 via any number of different interfaces, and music and other media files downloaded for portable use and viewing.

In some instances, the CPE 106 includes a DOCSIS cable modem for delivery of traditional broadband Internet services. This connection can be shared by all Internet devices in the premises 240; e.g., Internet protocol television (IPTV) devices, PCs, laptops, etc., as well as by roaming devices 290. In addition, the CPE 106 can be remotely managed (such as from the head end 150, or another remote network agent) to support appropriate IP services. Some embodiments could utilize a cloud-based user interface, wherein CPE 106 accesses a user interface on a server in the cloud, such as in NDC 1098.

In some instances, the CPE 106 also creates a home Local Area Network (LAN) utilizing the existing coaxial cable in the home. For example, an Ethernet-over-coax based technology allows services to be delivered to other devices in the home utilizing a frequency outside (e.g., above) the traditional cable service delivery frequencies. For example, frequencies on the order of 1150 MHz could be used to deliver data and applications to other devices in the home such as PCs, PMDs, media extenders and set-top boxes. The coaxial network is merely the bearer; devices on the network utilize Ethernet or other comparable networking protocols over this bearer.

The exemplary CPE 106 shown in FIGS. 5 and 6 acts as a Wi-Fi access point (AP), thereby allowing Wi-Fi enabled devices to connect to the home network and access Internet, media, and other resources on the network. This functionality can be omitted in one or more embodiments.

In one embodiment, Wi-Fi interface 302 comprises a single wireless access point (WAP) running multiple (“m”) service set identifiers (SSIDs). One or more SSIDs can be set aside for the home network while one or more SSIDs can be set aside for roaming devices 290.

A premises gateway software management package (application) is also provided to control, configure, monitor and provision the CPE 106 from the cable head-end 150 or other remote network node via the cable modem (DOCSIS) interface. This control allows a remote user to configure and monitor the CPE 106 and home network. Yet again, it should be noted that some embodiments could employ a cloud-based user interface, wherein CPE 106 accesses a user interface on a server in the cloud, such as in NDC 1098. The MoCA interface 391 can be configured, for example, in accordance with the MoCA 1.0, 1.1, or 2.0 specifications.

As discussed above, the optional Wi-Fi wireless interface 302 is, in some instances, also configured to provide a plurality of unique service set identifiers (SSIDs) simultaneously. These SSIDs are configurable (locally or remotely), such as via a web page.

As noted, there are also fiber networks for fiber to the home (FTTH) deployments (also known as fiber to the premises or FTTP), where the CPE is a Service ONU (S-ONU; ONU=optical network unit). Referring now to FIG. 8, L3 network 802 generally represents the elements in FIG. 1 upstream of the head ends 150, while head end 804, including access router 806, is an alternative form of head end that can be used in lieu of or in addition to head ends 150 in one or more embodiments. Head end 804 is suitable for FTTH implementations. Access router 806 of head end 804 is coupled to optical line terminal 812 in primary distribution cabinet 810 via dense wavelength division multiplexing (DWDM) network 808. Single fiber coupling 814 is then provided to a 1:64 splitter 818 in secondary distribution cabinet 816 which provides a 64:1 expansion to sixty-four S-ONUs 822-1 through 822-64 (in multiple premises) via sixty-four single fibers 820-1 through 820-64, it being understood that a different ratio splitter could be used in other embodiments and/or that not all of the 64 (or other number of) outlet ports are necessarily connected to an S-ONU.

Giving attention now to FIG. 9, wherein elements similar to those in FIG. 8 have been given the same reference number, access router 806 is provided with multiple ten-Gigabit Ethernet ports 999 and is coupled to OLT 812 via L3 (layer 3) link aggregation group (LAG) 997. OLT 812 can include an L3 IP block for data and video, and another L3 IP block for voice, for example. In a non-limiting example, S-ONU 822 includes a 10 Gbps bi-directional optical subassembly (BOSA) on-board transceiver 993 with a 10G connection to system-on-chip (SoC) 991. SoC 991 is coupled to a 10 Gigabit Ethernet RJ45 port 979, to which a high-speed data gateway 977 with Wi-Fi capability is connected via category 5E cable. Gateway 977 is coupled to one or more set-top boxes 975 via category 5e, and effectively serves as a wide area network (WAN) to local area network (LAN) gateway. Wireless and/or wired connections can be provided to devices such as laptops 971, televisions 973, and the like, in a known manner. Appropriate telephonic capability can be provided. In a non-limiting example, residential customers are provided with an internal integrated voice gateway (I-ATA or internal analog telephone adapter) 983 coupled to SoC 991, with two RJ11 voice ports 981 to which up to two analog telephones 969 can be connected. Furthermore, in a non-limiting example, business customers are further provided with a 1 Gigabit Ethernet RJ45 port 989 coupled to SoC 991, to which switch 987 is coupled via Category 5e cable. Switch 987 provides connectivity for a desired number n (typically more than two) of analog telephones 967-1 through 967-n, suitable for the needs of the business, via external analog telephone adapters (ATAs) 985-1 through 985-n. The parameter “n” in FIG. 9 is not necessarily the same as the parameter “n” in other figures, but rather generally represents a desired number of units. Connection 995 can be, for example, via SMF (single-mode optical fiber).

In addition to “broadcast” content (e.g., video programming), the systems of FIGS. 1-6, 8, and 9 can, if desired, also deliver Internet data services using the Internet protocol (IP), although other protocols and transport mechanisms of the type well known in the digital communication art may be substituted. In the systems of FIGS. 1-6, the IP packets are typically transmitted on RF channels that are different that the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve. Furthermore, one or more embodiments could be adapted to situations where a cable/fiber broadband operator provides wired broad band data connectivity but does not provide QAM-based broadcast video.

Principles of the present disclosure will be described herein in the context of apparatus, systems, and methods for electronic devices, networking and network management. It is to be appreciated, however, that the specific apparatus and/or methods illustratively shown and described herein are to be considered exemplary as opposed to limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

Generally, techniques are provided for dynamically constructing a hardware test environment based on the upcoming tests in a test queue (e.g., in advance of test execution). In one or more example embodiments, a queue or queues of upcoming tests is/are analyzed and the appropriate hardware resources are prepared accordingly. This preemptive approach significantly reduces test execution time, streamlines the testing process, and enhances overall testing efficiency. Indeed, one or more embodiments provide techniques for dynamically building a test environment based on a test queue-a hardware test environment is a non-limiting example. One or more embodiments can be used to validate firmware on devices; to test code in a virtualized environment, and the like. One non-limiting example of a test solution that can be used in connection with one or more embodiments is the CDROUTER® test solution for networking products (registered mark of QA CAFE, LLC, Portsmouth, New Hampshire, USA) (other solutions providing a virtualized device in software that can be used to test firmware can also be employed, for example).

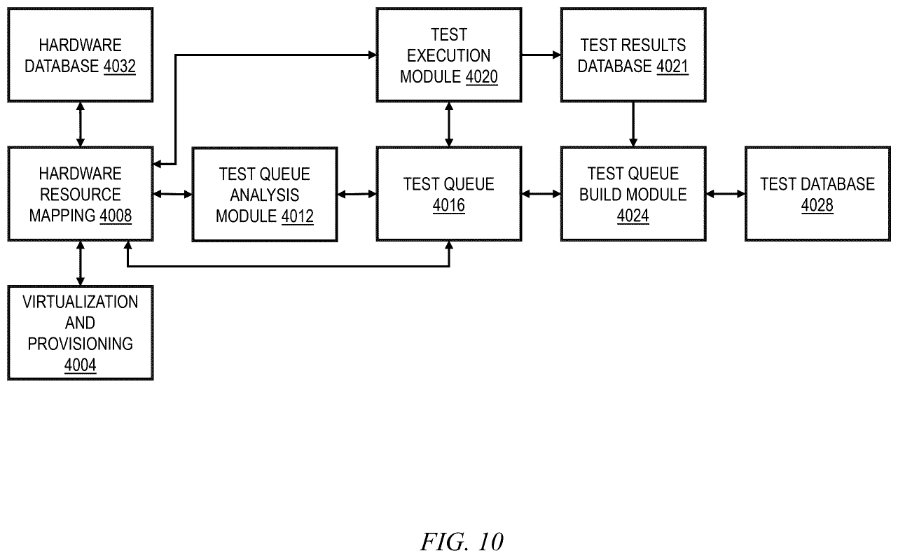

FIG. 10 is a block diagram of an exemplary system for dynamically constructing a hardware test environment, which also functions as a workflow diagram, in accordance with an exemplary embodiment. In the example, a test database 4028 maintains a set of tests for testing hardware, software, firmware and the like, with information associated with the tests. A test queue build module 4024 generates a queue of tests to be executed (e.g., placed in test queue 4016) based on the set of tests in the test database 4028. A test queue analysis module (TQAM) 4012 obtains tests from the test queue (TQ) 4016 and device and equipment status information, such as availability information, from a hardware resource mapping module (HRMM) 4008, and determines a series of test configurations, an order of test executions, and the like. A virtualization and provisioning module (VPM) 4004 instantiates virtual resources and/or provisions physical resources for executing the tests. A suitable hypervisor program can be used for virtualization, for example. A test execution module 4020 then executes the tests in the test queue 4016.

In one or more exemplary embodiments, the test queue will include only a single queue. In one or more embodiments, the test execution module 4020 monitors this single queue for tests ready to run by verifying the existence of the test environment unique ID (see further discussion below) and that the test environment unique ID is not already executing a test it is conducting. Once a test completes, the test execution module 4020 will update the queue to indicate test completion. Furthermore, in one or more embodiments, the test queue analysis module 4012 reads the test queue for tests that lack a test environment unique ID, which is its identifier that a test environment has not been created. The test queue analysis module 4012 then determines if an existing environment is sufficient, at which point it assigns that ID to the test or it commands the hardware resource mapping module 4008 to build an environment for that test. Even further, the hardware resource mapping module will read the queue 4016 for the specific components required for the test's environment and once built will update the test queue with the test environment unique ID. In some cases, the hardware resource mapping module will also monitor the queue for test environments not in use and set them for destruction. That is to say, optionally, the HRM 4008 is in charge of destroying the environment and monitoring for such destruction. Note, however, that there is a race condition possible here, so in an alternative approach, the destruction of an environment passes back through the test queue analysis module instead. In this alternative approach, however, the TQAM 4012 monitors for destruction since, if the TQAM sees an environment to use at the same time the HRM 4008 wants to destroy it, the aforementioned race condition could exist. Instead, in the advantageous alternative approach, the TQAM monitors for when to destroy the environment and passes that decision back, which eliminates the potential race condition.

Still further, the test queue build module 4024 monitors the total amount of tests in a pending state in the test queue 4016. Using a preconfigured limit PCL, it will add tests as appropriate to the queue until there are sufficient tests pending to ensure the test queue analysis module is operating efficiently and has sufficient data to make decisions that maximize the utilization of the environment. For example, PCL can determine, based on various factors such as the size of the test environment, how to optimize the system. Given the teachings herein, and the size of the available text environment, the skilled artisan can determine an appropriate value for PCL heuristically. If it is too high, there will be too many tests for the queue to process; if it is made too low, the system will not run optimally. In one or more embodiments, the TQAM 4012 passes instructions to the HRM module 4008 and the HRM module 4008 communicates to what is behind it (e.g., virtualization and provisioning module 4004). It is worth noting that optionally, multiple queues could be maintained in queue 4016 for each of the modules that access it. On the other hand, one or more embodiments use a single queue, and the existence/non-existence of certain fields in each entry indicates the current stage. Furthermore in this regard, one or more embodiments have three stages: (i) a test that has just been added to the queue (analysis is run, this test is the next one, there is an open slot, put the test in the open slot); (ii) the TQAM 4012 has said that the test should run now, has reordered the test's queue position, confirms whether created, and confirms ready to run; and (iii) tests that are actually ready to go. This can be accomplished with three separate queues, where each piece uses individual parts; in a unified queue; in two queues (one combined and one separate); etc. Thus, in one or more embodiments, there are three different categories but they can be in separate queues, identified in some manner in a single queue, etc.

Further regarding the test environment unique ID, when a test environment is built, in one or more embodiments, it is desirable to be able to assign it out to multiple tests. Consider a “Test A” which simply seeks to verify whether radios are turned ON/OFF at the appropriate time. This is an example of a non-destructive test. Further consider that a subsequent desired operation could involve a firmware update (would be destructive as the test environment would no longer match its original specification). In one or more embodiments, instead of building and destroying multiple test environments, it is desirable to be able to reuse a test environment and keep track of it across various modules, such as the hardware resource module, the test queue analysis module, and the test execution module. All those modules typically require a common reference as to where they are supposed to be testing, and in one or more embodiments, which is provided by the test environment unique ID. In one or more embodiments, when a test environment is instantiated, it is assigned a test environment unique ID (for example, generated by the TQAM and passed back to the hardware resource module for handling).

### Test Database

The test database (TD) 4028 list candidate tests including, for example, a script to run the corresponding test. The TD 4028 also specifies, for example, the minimum set of equipment needed for each test, information needed by the test environment to execute the test, the number of times to run a test in a given time period (or a relative weighting stating how often the test should run compared to other tests), information on the destructive or non-destructive nature of the test and the like. For the tests that are not specified to run a certain number of times in a given time period, weighting can be used to prioritize a test relative to other tests. Module 4024 reads data from database 4028 in one or more embodiments. The TD 4028 can be implemented, for example, using a suitable relational database management system (RDMS). The records could include, for example, test name; test instructions; a hardware requirements list; test frequency, test weight, or both. In one or more embodiments, the test database 4028 includes tests that will be run as well as tests that may be run in the future. For example, there can be two categories of tests:

1. Tests that must run a set number of times over a set period. These tests can be, e.g., business requirement type tests. For example, a product requires that twenty speed tests be performed on each device daily and that the expected requirements are met. These tests should have priority in one or more embodiments.

2. Tests that it is desired to run, but which do not have a requirement on how often. In one or more embodiments, these tests should be given a numerical weight as opposed to a frequency. For example, consider a test ensuring that the router responds to a remote reboot command.

In one or more embodiments, a general overall goal is to ensure that the environment maximizes its utilization by allocating resources not actively engaged in executing the first category of tests to the second. A test could, for example, be in both categories by assigning it a frequency and a weight. In that case, it executes with category 1 priority until reaching the necessary number of executions to meet the frequency assigned. It then executes with category 2 priority.

In a non-limiting example, tests are maintained in the database 4028 rather than directly input to the module 4024, to ensure consistency in execution. A test that only needs to be executed one time could, for example, be added with a very low frequency such as one time over 100 years.

A variety of weighting techniques could be used. In one aspect, a simple numerical weighting system can be employed: each test is assigned a numerical weight for how often it should execute relative to other tests. In a non-limiting example, using a scale of 1-100 creates the priority for test execution. If Test A is given a weight of 10 and Test B is given a weight of 50, Test B should execute five times for every time Test A executes over a given timeframe. If neither test executed in the current timeframe, the system randomly chooses one. For example, suppose that neither test has executed yet and there is room for one test. The system (e.g., the build module 4024) calculates which test to run.

Furthermore in this regard, given that neither test has run, the system (e.g., the build module 4024) executes a special case and assigns both tests the highest priority; in this example, a value of 101 (one more than the highest possible weight of 100). The system (e.g., the build module 4024) randomly chooses Test B and adds it to the queue. Now, when a second slot comes free, the system (e.g., the build module 4024) knows it has already added Test B to the queue once, so it analyzes priority again. Since Test A has not run, it is assigned a priority of 101. Test B priority is then determined by computing its weight divided by the number of executions:

$$Test A priority = 101$$

$$Test B priority = 50 / 1 = 50$$

Since Test A has the highest priority, it is added to the queue. When another slot comes free, the priority is recomputed:

$$Test A priority = 10 / 1 = 10$$

$$Test B priority = 50 / 1 = 50$$

Test B will execute. Repeating this will result in Test B executing approximately five times more often than Test A.

It is worth noting that a developer platform with versioning capability, or other versioning software, a non-limiting example of which includes GitHub, could be used as a source control versioning for the test data and its execution. As the environment setup and test execution methodology can be somewhat complex in some cases, the test database 4028 can in some instances reference a system such as GitHub, instead of containing the programmatic elements of a test.

### Test Queue Build Module

In one or more embodiments, the test queue build module 4024 determines the test(s) to run on the hardware test environment, obtains the test(s) to run from the test database 4028, and creates the test queue 4016 of tests used to configure the test environment for execution. In the example of FIG. 10, test results database 4021 is populated by the test execution module 4020 and the TQBM 4024 reads from it. Database 4021 can be implemented with a suitable database program and exemplary records include the test that was run based on ID, test environment unique ID so it is known what hardware the test ran on, and the results of the test and/or location where the test was (e.g., pointer to where test results are e.g. flat file system). In one example embodiment, the test queue build module 4024 creates the test queue 4016 based on the number of tests required to fully utilize the test environment and to ensure that there is a healthy number of tests in the backlog (to ensure a continuous utilization of the test environment). The test queue build module 4024 provides input for the test queue analysis module 4012 via the test queue 4016. In one example embodiment, the test queue build module 4024 is run in Python. Regarding the “healthy number,” in one or more embodiments, this is the preconfigured limit PCL mentioned above with regard to the test queue build module 4024. Selection of this number can be based, for example, on several things. Non-limiting example of influencers in the selection of this number include:

1. The ratio of non-destructive to destructive tests. In one or more embodiments, a higher percentage of destructive tests (ones that preclude reuse of the environment without a complete reset) reduces overall efficiency so that a larger backlog would be desirable to increase the possibility of having a nondestructive test in the queue to improve efficiency.

2. Environment Size. The larger the test environment, the more simultaneous tests can be run, and therefore a larger queue improves efficiency. Conversely, a smaller environment reduces this limit.

3. Expected vs. Actual test runs. If the test queue is too large, the system (i.e., the system as a whole) may end up not running destructive tests as often as needed. This ratio can be adjusted in several ways; reducing the backlog is one non-limiting example.

4. One-off test timing. If a certain test needs to be executed in near real time for any reason, a large backlog potentially limits how long it will take to reach the queue.

5. Programmatic limits. As the TQAM 4012 will, in one or more embodiments, attempt to reorder the queue, the complexity of the problem becomes more difficult with each additional item added to the queue.

In one or more embodiments, a user enters a request to run a test by having it inserted into the test database 4028. Optionally, an “admin” is located between the user and the database 4028. That is to say, tests should preferably only enter the queue through the database—for example, front-ended by a web page. Alternatively, one could just type SQL commands right into the database. In one or more embodiments, the TQBM 4024 handles the initial parameters as discussed elsewhere. That is to say, in some instances, there are two categories of tests-(i) tests specified by frequency such as must run twenty times per day; and (ii) tests where it is desired to do as many as possible per day (e.g., 5, 100, 1000), based on weight. Tests in this latter category ca be weighted to maintain a consistent percentage. Some tests could be in both categories. In one or more embodiments, the TQBM 4024 adds entries to the queue 4016 based on the test database. The TQAM 4012 can adjust those parameters should it find the opportunity to do so. For example: Test A is destructive and entered into the queue 4016. It is the only test that utilizes Environment A. While Environment A is being built and readied, Test B is placed into the queue 4016 by the TQBM 4024. It is nondestructive and can also utilize Environment A. The TQAM 4012 then determines if it should reorder the queue 4016 so that Test B runs first, thereby reducing environment build time. Colloquially, it might be said, as a helpful visualization, that the TQBM drops building bricks which are stacked by the TQAM.

Further regarding examples of tests that fall into both categories, consider a simple tests which determines whether a successful connection to the Internet can be made. Suppose it is always desired to run this test 50 times in a certain time period. It may also be desired to test connectivity on a large scale so that a certain reliability level can be ensured—say 99.99%. Such a test could accordingly be specified based on both frequency and weight—the test could be specified to run at least 50 times per time period, and in the remaining available time, be weighted such that 10% of available tests are the Internet connectivity test. In this manner, the minimum number is always achieved, and the additional desired testing allowing for a higher confidence level is also accomplished by specifying weight as well as frequency.

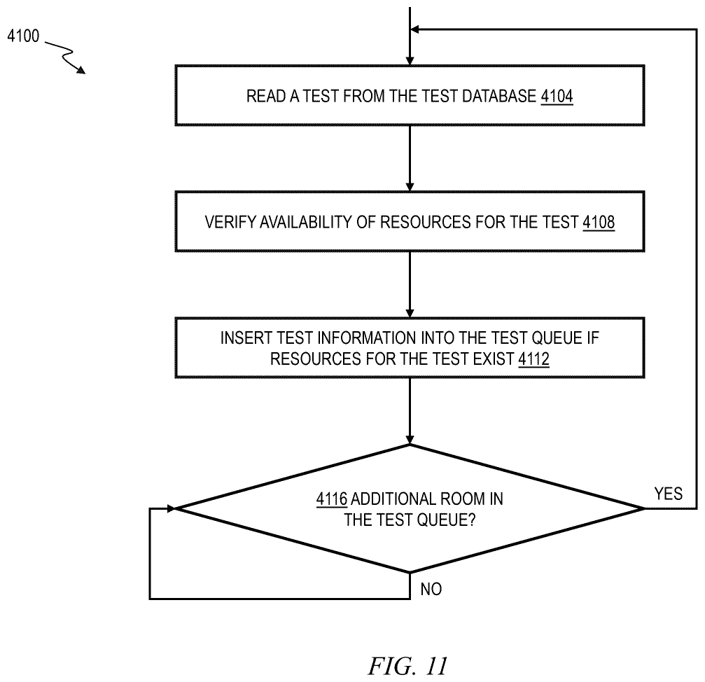

In example embodiments, TQBM 4024 is implemented by a program (e.g., custom software written in a high-level language and compiled or interpreted into machine-executable code, and which that implements logic of the flow chart of FIG. 11, including picking specific tests) configured to read the test database 4028 and add tests to the test queue 4016 using the following criteria:
(i) prioritize tests that need to execute a certain number of times in a given period as required; and
(ii) if no test needs to be run based on the above, select the test to run based on the weighting algorithm.

It is worth noting that, while tests may be in both categories in the database, in one or more embodiments, only one category will be selected by the TQBM and entered into the TQ data (the selection of which is determined by whether it enters the queue based on (i) or (ii) above).

FIG. 11 is a flowchart 4100 for a method to build test queues 4016, in accordance with an exemplary embodiment, which can be implemented, for example, by module 4024. In the example embodiment, a test is read from the test database 4028 (operation 4104). The hardware resource mapping module 4008 is accessed to verify the availability of viable hardware for the test that was read in operation 4104 (operation 4108). If the resource is in use and no suitable replacement exists, the HRMM 4008 states that it could not build the test environment, and the TQAM 4012 analyzes the queue 4016 again for the next test to see if an environment can be built. This is part of the reason for environment size serving as an influencer, as discussed above. If the resources for the test exist, the test information for the corresponding test is inserted into the test queue 4016 (with a unique ID) (operation 4112) (i.e., inserting a queue entry in queue 4016). A check is performed to determine if there is additional room in the test queue 4016 (decision block 4116). If there is additional room in the test queue 4016 (YES branch of decision block 4116), the method 4100 proceeds with operation 4104 to ensure that a sufficient backlog of tests exists in the test queue 4016; otherwise, (NO branch of decision block 4116), the method 4100 waits for there to be additional room in the test queue 4016; comparison can be made to the aforementioned PCL parameter, for example.

### Test Queue

In one or more embodiments, test queue 4016 is implemented as a database (such as any relational database management system (RDBMS) or other suitable database or data structure) that maintain tests ready to be analyzed and tests ready to be run. The test queue 4016 contains an identifier for the hardware resources used in a test, the scripts (such as a Python® script (registered mark of PYTHON Software Foundation, Beaverton, OR USA) or an Ansible® script (registered mark of RED HAT, Inc., Raleigh, NC, USA)) to be used to execute the specific test, and a priority based on a weighting system for defining how critical the test is. For example, a test for a new software release may be assigned a high priority. Note that non-limiting examples of suitable database software for any of the databases discussed herein include MONGODB® (registered mark of MONGODB, INC., New Yor, NY, USA) and MYSQL® (registered mark of Oracle Svenska AB, Solna SWEDEN). As noted above, in one or more exemplary embodiments, the test queue will include only a single queue.

In one or more embodiments, the test queue 4016 maintains the following information about tests to be run:

data from the test database 4028 that was populated by the test queue build module 4024;
hardware required for each test;
scripts to execute each test (e.g., speed test, API call, . . . )
a unique ID populated by the test queue build module 4024;
a flag to indicate if the test is running as (a) a weighted test or (b) a times per period test, as populated by the TQBM 4024, and a weight in case of being a weighted test (as noted above, while tests may be in both categories in the database, in one or more embodiments, only one category will be selected by the TQBM and entered into the TQ data-thus, in one or more embodiments, the flag indicates (a) or (b) rather than (a) and/or (b)).
a flag to indicate if the test is ready to run, as populated by the TQAM 4012 or the hardware resource module 4008 (in principle, the flag can be the existence of the environment ID itself as provided by the HRM 4008, but it can also be handled by the TQAM 4012 seeing the environment ID itself; in one or more embodiments, this is advantageously handled by the TQAM to prevent a race condition from occurring);
a test environment unique ID, populated by the test queue analysis module 4012; and
an order to run on the test environment, as populated by the test queue analysis module 4012.

It is worth noting that the order to run can be maintained and updated by the TQAM 4012 based on programmatic decisions; for example, one pertinent aspect is insuring that no non-destructive test was ordered behind a destructive one. In one or more embodiments, a human subject matter expert (SME) determines whether a test is destructive.

### Test Queue Analysis Module (TQAM)

In one or more embodiments, the TQAM 4012 continuously monitors the test queue 4016 for pending tests and queries the hardware resource mapping module 4008 to identify the specific hardware resources required for each test based on the given test specifications, such as the required devices, interfaces, protocols, and configurations. In one example embodiment, the test queue analysis module 4012 queries and monitors the test queue 4016 at regular intervals. When the test queue analysis module 4012 determines that a test should be run, the TQAM 4012 provides the specifications of the hardware needed to run the test to the hardware resource mapping module 4008. In one example embodiment, the test queue analysis module 4012 identifies the resources needed for each test (by accessing the HRMM 4008) and attempts to pair up tests from the test queue 4016 such that tests with similar resource requirements run on the same test configuration sequentially, in parallel, or both. In one example embodiment, the test queue analysis module 4012, when creating the test environment and scheduling the tests for execution, considers the priority of the test, the runtime of the test, the time to build the environment, and an indication of whether the test can run on an existing configuration, a configuration scheduled for implementation, and the like.

In one example embodiment, the test queue analysis module 4012 is implemented using one or more Python scripts). For example, to test that a cable modem appropriately provisions additional bandwidth when responding to a speed boost test, the particular type of device under test; e.g., advanced Wi-Fi router or cable modem provisioned may not be important; it is, however, typically necessary to verify that the CMTS being communicated with is providing the appropriate service. Thus, a request for a generic cable modem, a generic advanced Wi-Fi router device, and a mobile speed boost client can be submitted to the HRMM 4008 to provision for the speed boost test. On the other hand, a more complex request would be for a specific model of modem from a particular manufacturer provisioned at specified speeds, and an American Standard Code for Information Interchange (ASCII) device for advanced Wi-Fi. That is to say, advantageously, one can broadly define devices and then have smaller sub-buckets, allowing for efficient test device utilization. For example, a device could be specified from broadest to narrowest as a Wi-Fi router, an advanced Wi-Fi router, a Wi-Fi-router of a certain generation, a Wi-Fi router from a specific manufacturer, or a specific model number of Wi-Fi-router.

In one or more embodiments, TQAM 4012 reads and updates test queue 4016 and provides hardware and test environmental data to HRMM 4008 so that the required test environment for tests that can be executed at that time can be instantiated. TQM 4012 can include suitable logic. For example, suppose tests 1, 3, 17, and 40 can all run in environment “A” while test 4 is critically important and needs equipment in environment “A.” The TQM can prioritize appropriately with a goal of maintaining high utilization; for example, a utilization rate of at least 80%. One or more embodiments advantageously instantiate test configurations for different tests based on hardware availability and the criticality of the tests.

In one or more embodiments, tests that are prioritized to execute a specified number of times in a given time period are given priority and executed as specified. If there are no prioritized tests, tests are selected to be run based on the assigned weightings. The HRMM 4008 is then accessed to determine if physical or virtual resources exist to execute the test. These steps are repeated to ensure that a sufficient queue of tests exists to efficiently utilize the test environment.

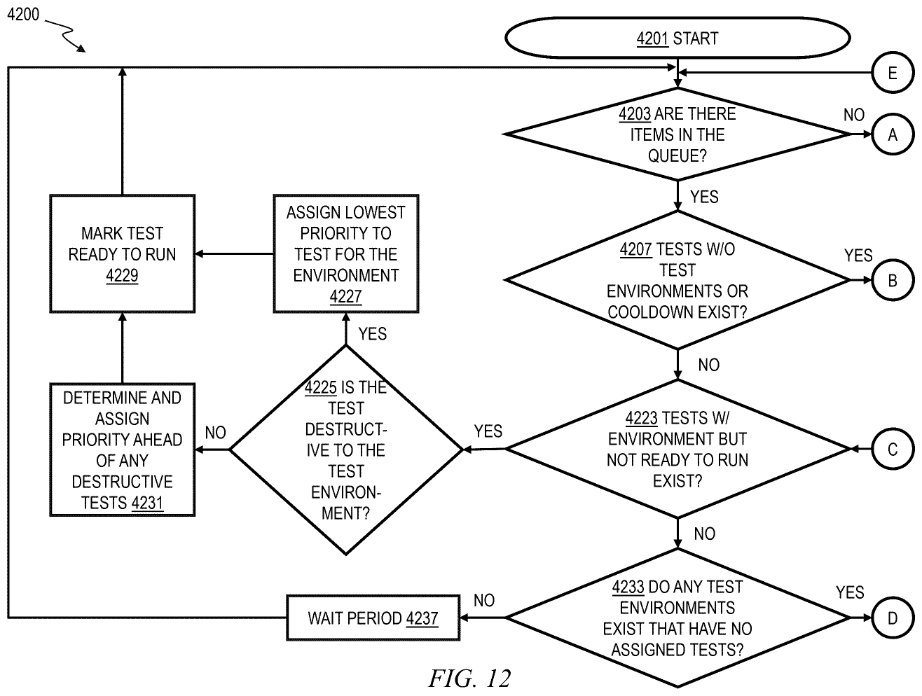

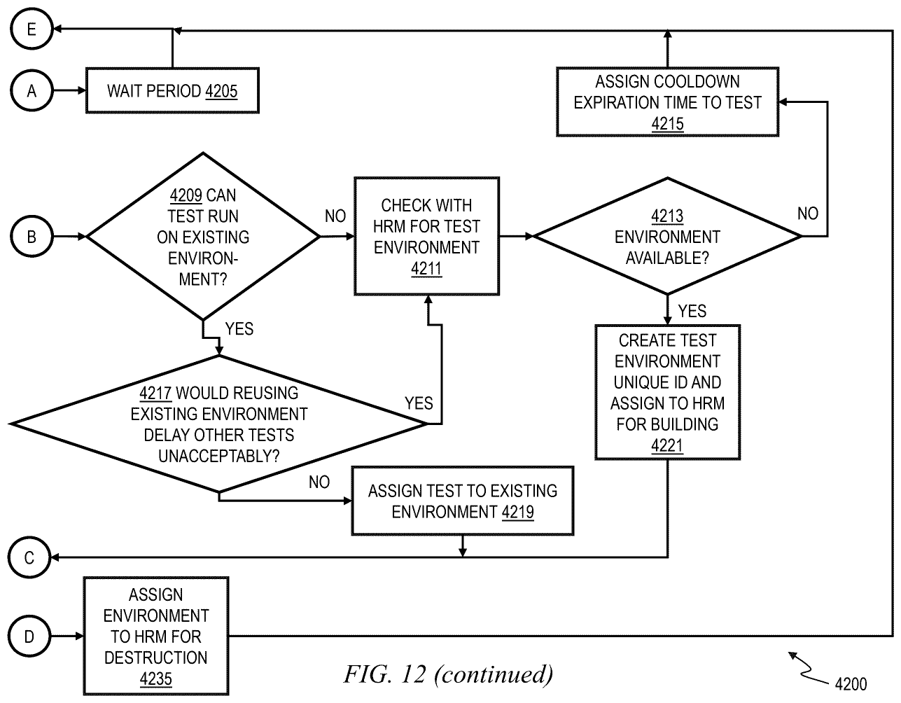

FIG. 12 is a flowchart 4200 for a method for analyzing and orchestrating tests in the test queue 4016, in accordance with an exemplary embodiment (it can be implemented, for example, by module 4012, which can be a program (e.g., custom software written in a high-level language and compiled or interpreted into machine-executable code, and which that implements logic of the flow chart of FIG. 12) that reads the test queue and available test equipment (provided by the hardware resource module) and requests test environments to be created in an optimal way). In the example, one or more tests are read from the test queue 4016 to identify entries (tests) lacking a test environment and the available resources for optimally defining and creating a test environment or environments are identified (as provided by the hardware resource mapping module 4008).

Referring now to flow chart 4200, after starting at 4201, check the test queue at decision block 4203. If there are no items in the queue (NO branch), wait for a predetermined period (e.g., 30 seconds, one minute, five minutes) at 4205 and then repeat the check in decision block 4203. If there are items in the queue (YES branch), proceed to decision block 4207 and determine whether tests without test environments or cooldowns exist. Recall the discussions elsewhere about how there can be three different queues or a single combined queue, for example. If there is a new test added from the build module, as per the YES branch of block 4207, logical flow proceeds to decision block 4209 where a determination is made whether the test can run on an existing environment. If YES, proceed to decision block 4217 and determine whether reusing the existing environment would unacceptably delay other needed tests. Given the teachings herein, the skilled artisan can heuristically select a threshold or the like as a function of test frequency, test weight, and the like to check for unacceptable delay.

Furthermore in this regard, in one or more embodiments, it is appropriate to have a programmatic break to protect from a situation where the system keeps moving non-destructive tests in front of destructive test(s). Suppose there are 1000 tests that could use the environment. It may not be appropriate to run them all linearly because it may take too long. One or more embodiments provide a programmatic break to limit the number of tests. If the programmatic break is not exceeded (NO branch), enter the test queue and assign it to an existing test environment at 4219. If the programmatic break is exceeded (YES branch), proceed to step 4211 and check with the HRM for a test environment. Step 4211 is also reached by the NO branch of block 4209 when it was determined that the test could not run on an existing environment. In decision block 4213, the HRM determines whether the environment is available (i.e., can be presently built). If NO, proceed to step 4215 and assign a cooldown expiration time (e.g., 3 minutes) to the test and then logical flow proceeds to decision block 4203.

If the environment can be built (YES branch), proceed to step 4221 and create the test environment unique ID and assign the test to the HRM module 4008 to be built. Logical flow then proceeds to decision block 4223 where it is determined whether there are tests with an environment but not yet ready to run. In one or more embodiments, it is desirable not to start by determining whether the test can run, but rather to first verify existence of the build environment, to prevent certain race conditions. It is desirable to ensure that the system does not destroy an environment when it is trying to run a test on it. Optionally, the test execution module reads a ready to run flag to determine whether the process is good to go (alternatively, the decision to “go” is simply tied into the environment itself being activated, particularly in cases where the item is not being deleted from the queue until the test is successfully completed). As noted above, in some cases, the hardware resource mapping module will also monitor the queue for test environments not in use and set them for destruction, but that results in a potential race condition. Accordingly, one or more embodiments use the above-discussed alternative approach, wherein the TQAM monitors for when to destroy the environment and passes that decision back, which eliminates the potential race condition.

If there are tests with an environment, but not ready to run (YES branch of decision block 4223), proceed to decision block 4225 and determine whether the test is destructive. If so (YES branch), proceed to step 4227 and assign the lowest priority, because this test will destroy the environment so that no further tests can be run (e.g., test shuts down router requiring external intervention; test fills up disk so router crashes, and the like). If the test is not destructive (NO branch of decision block 4225), then proceed to step 4231 and programmatically determine where in the queue it should go (ahead of any destructive test) and mark as ready to run in step 4229 and then proceed to decision block 4203. The test could just be placed one test ahead of the destructive test but could also be flagged for further acceleration.

From the NO branch of block 4223, proceed to decision block 4233 and see if anywhere exists that has no assigned tests. If YES, assign that environment to the HRM for destruction in step 4235. The hardware is recycled to a clean state so it can be rebuilt into a different environment. If NO, wait for a predetermined amount of time (e.g., 30 seconds) in step 4237 and then proceed back to decision block 4203. In one or more embodiments, the TEM 4020 “pulls” items out of the queue 4016 to run, but the TEM preferably only deletes the item at the end of the test; that way, the item is not lost in case of a failure to complete the test.

Thus, a pertinent aspect in one or more embodiments is the use of the TQAM to improve the efficiency of testing. Indeed, instead of a prior art linear testing methodology, one or more embodiments advantageously use the test environment in non-linear manner, using programmatic code to proactively reorder the tests and maintain the test hardware environment. For example, in a prior art manual system, a human operator would say, I have to run tests 1-100, I will execute them in numerical order as 1, 2, 3, . . . , 100. In contrast, one or more embodiments might instead run the tests in an optimal manner as 1, 6, 12, 33, 9 . . . and then go to another test environment and run 62, 14, 33, 11, allowing for faster completion of the complete set of tests, using the test equipment more efficiently with less down time.

### Hardware Database

A hardware database 4032, such as a relational database management system (RDBMS), maintains information on the lab environment as well as existing test environments. In one or more embodiments, the hardware database 4032 maintains data on all physical and virtual components in the lab, including the state of the physical and virtual components, such as assigned to a test configuration, idle, available, and the like. In one or more embodiments, the hardware database 4032 also maintains data on the status and configurations of the active test environments. HRMM 4008 can query database 4032 and provide a list of equipment to be provisioned to module 4004.

### Hardware Resource Mapping Module (HRMM)

The HRMM 4008 maintains a list of available components (i.e., reads and updates hardware inventory database 4032) and, upon analyzing a set of upcoming tests, dynamically maps the required hardware resources to available physical devices. The HRMM 4008 optimizes resource allocation to minimize conflicts and maximize parallel test execution. In one example embodiment, the HRMM 4008 may specify virtual resources when hardware resources are not available, when hardware resources are not a cost effective alternative, to minimize resource conflicts, to maximize parallel test execution, and the like. In one or more embodiments, HRMM 4008 searches test queue 4016 for the next test environment to build/destroy. Components can be considered as available, for example, when they are not locked for testing or broken.

The HRMM 4008 determines the specific device to provide in response to a request. In one example embodiment, the results are sent to the VPM 4004 to instantiate virtual resources, provision physical resources, or both. The virtualization environment can be implemented, for example, with VMware® ESXi bare metal hypervisor, available from Broadcom Inc. Palo Alto, CA USA, for hosting virtual machines and Red Hat Enterprise Linux on a virtual machine (VM) to host the Docker® containers (registered mark of Docker, Inc. San Francisco, CA, USA). Thus, either a virtual machine or a Docker® container can be allocated in response to a request for test resources.

In one example embodiment, to implement HRMM 4008, a program (e.g., custom software written in a high-level language and compiled or interpreted into machine-executable code, and which that implements logic described herein) is configured to monitor the test queue 4016, monitor the availability of equipment, and provide a mapping of equipment for a test environment. Such a custom program can have three functions, for example. In a first function, HRMM 4008 responds to requests from the TQAM to see if it can build an appropriate environment. In a second function, if it does have such ability, it builds the appropriate environment and sends everything to module 4004, advising module 4004 what specific piece of hardware to use. Module 4004 then advises module 4008 when it is done. HRMM 4008 then indicates that the test environment is built. In a third function, the HRMM 4008 destroys the test environment to reset it when needed (see discussion of environment discussion elsewhere herein, noting that in the advantageous alternative approach, the TQAM monitors for when to destroy the environment and passes that decision back, which eliminates the potential race condition). In one or more embodiments, when the TQAM determines that the test environment is no longer needed, it advises the HRMM 4008.

In one or more embodiments, HRMM 4008 includes logic needed to select specific equipment when ambiguity exists. For example, if a component is specified at a high level of generality such as a Wi-Fi router, the logic decides to use whatever model of Wi-Fi router has the largest number in stock, or simply any available Wi-Fi router, whereas if the component is specified more narrowly, the particular specified component is selected. Such logic can be implemented in PYTHON or similar programmatic language code to query the DB 4032 and process through the eligible environments and either just return that it can do what is requested or pass down to the module 4004.

The program notifies the virtualization and provisioning module 4004 when hardware for a new environment is ready, reads the test queue 4016 to find the first unbuilt test environment that is needed and that can be created, provides existing test environment capabilities and an identity of available hardware to the test queue analysis module 4012 via an application programming interface (API), and marks equipment as in use or available in the hardware database 4032. The program also determines common test environment configurations and maintains them in a standby state. Thus, in one or more embodiments, the HRMM 4008 provides basic optimization tasks by choosing the least utilized equipment when it has a choice. As an example, if device A and device B can both fulfill a request, the HRMM knows that the current utilization of all hardware classified as device A is 90%, and device B is 0%. It then picks device B to fulfill the requirement. In one or more embodiments, the maintenance of the standby configurations does not interfere with the task of the TQAM. When queried for the availability of a standby environment, the HRMM responds that it is available. The TQAM immediately returns the request to assign the environment to a test and the HRMM updates the test queue with the environment ID. The HRMM 4008 then determines, based on its configuration, if it should build an additional standby environment or not. In one or more embodiments, the TQAM 4012 performs optimization and the HRMM 4008 simply picks a particular instance of an available resource in response to a request for equipment from the TQAM.

### Virtualization and Provisioning Module

In one or more embodiments, the HRMM 4008 triggers the virtualization and provisioning module (VPM) 4004 when needed. VPM 4004 instantiates virtual resources and provisions physical resources, such as network components, CMTSs and the like, to create a test environment. In cases where physical devices are limited or unavailable, the system utilizes virtualization techniques to provide the requested resource. The virtual resources, physical hardware instances, or both are provisioned and configured by the virtualization and provisioning module (VPM) 4004 to mirror the required specifications of the upcoming tests.

In addition to instantiating virtual resources, the VPM 4004 connects, for example, the network switches in an appropriate way so that the Docker® containers are either on the local area network side, the wireless network side, or the wide area network side of the advanced Wi-Fi router. In one or more exemplary embodiments, an Ansible® automation controller is used for at least a portion of the VM building and, once the VM is built out, is used to configure the network and the network switches. One non-limiting example of a suitable manufacturer of switches is Cisco Systems, Inc., San Jose, CA USA.

In one example embodiment, the VPM 4004 is implemented by configuring a program (e.g., custom software written in a high-level language and compiled or interpreted into machine-executable code, and which implements logic described herein, but can also make use of existing commercial software packages) to interact with the physical and virtual infrastructure in the lab (i.e., test laboratory) to create and destroy testing environments. For example, the VPM 4004 can be a mixture of components configured to interact with all of the components on the back end. The VPM 4004 can communicate with various components such as a hypervisor, a machine running Docker® software to start a Docker® container on that server, and the like (registered mark of Docker, Inc., San Francisco, CA, USA). Additional functionality can include, for example, switching through an Ansible® automation controller to carry out configuration, deployment of appropriate firmware, and the like. An Ansible® automation controller is a non-limiting example of a suitable program; any similar commercially available intermediate program can be used or custom code can be written in PYTHON or other suitable language to interface directly with a suitable hypervisor such as VMWARE® (registered mark of VMWare, Inc., Palo Alto, CA, USA). For example, some embodiments could use an engine written in PYTHON or the like that coordinates operations and interfaces with intermediate programs such as Ansible® automation controller—such an engine could interact directly with environments and/or could interacts with environments though intermediate program(s)/tools. A Docker® container is a non-limiting example of a standard unit of software that packages up code and all its dependencies so the application runs quickly and reliably from one computing environment to another. Test environments can be built in parallel as the locking of specific hardware is handled by the hardware resource mapping module 4008. The program builds and destroys virtual machines as needed, builds and destroys container environments as needed, and configures physical hardware as required to perform the specified testing.

### Test Execution Module

In one or more embodiments, the test execution module (TEM) 4020 runs the tests identified by the test queue 4016 and ensures that the tests are run after the dynamic resource adjustment has been performed and the test environment has been configured. Once a test is complete, the TEM 4020 writes the log file, the test results, and the like into the test database 4028.

In one or more exemplary embodiments, to implement TEM 4020, a program (e.g., job control language or the like, and which implements logic described herein,) is configured to read the test queue 4016, execute the required tests, monitor the testing environment to ensure that tests do not impact testing in progress, request additional resources when needed from the hardware resource mapping module 4008 (if available), and pause tests when resources are not available until the resource conflicts are resolved. TEM 4020 is configured to run the tests when they are ready, monitor the tests, pause a test if resource contention is detected or the test is taking too long, or the like. TEM 4020 can also include code segments to find out what is wrong if a test fails, such as equipment failure or the like, and to request replacement equipment. With regard to the latter point, suppose a cable modem fails in the middle of a test. The TEM can go back and replace the failed with another, similar cable modem and fix the test environment. Basically, in one or more embodiments, TEM 4020 takes data seen in the queue 4016 and determines how to run the test; monitors the test once it is running, and when the test is complete, writes the results into the database 4021, marks the test as done in the queue 4016/removes the test from the test queue. TEM 4020 can be implemented, for example, in PYTHON or another high-level language interacting with the databases and other modules. TEM 4020 could include, for example, conditional statements and loop to run/monitor, run/monitor, run/monitor. TEM 4020 requests replacement resources from HRMM 4008 when needed, and reads and updates the test queue 4016.

### Environment Preparation

Once the hardware resources are identified and allocated, the system (e.g., module 4004 thereof) proceeds to prepare the test environment for test execution. This includes configuring devices, setting up communication channels, loading the necessary firmware/software on devices under test, and establishing test parameters. For example, a device could be configured in a degraded state, configured to turn off the Wi-Fi, and the like. In one or more exemplary embodiments, the environment preparation is provided by the VPM 4004. Optionally, a health check can be provided as a component of the virtualization and provisioning module 4004 (or separately), that verifies that unused equipment is in a healthy state on a routine basis.

### Triggered Environment Activation

Generally, the prepared test environment remains in a standby state, ready for immediate activation. In one or more embodiments, as soon as a test is scheduled and configured to execute, the corresponding environment is triggered for activation by the test execution module 4020.

### Parallel Environment Building

In one or more embodiments, the system can build multiple test environments in parallel for upcoming tests that can run concurrently. This parallelization further enhances testing efficiency and reduces overall test cycle time. The parallelization can be coordinated, for example, by the test queue analysis module 4012.

### Dynamic Resource Adjustment

In one or more embodiments, during test execution, the system continuously monitors resource utilization (including network utilization). If additional resources are needed or conflicts arise, adjustments are made dynamically to ensure uninterrupted testing (e.g., by TEM 4020 using Ansible® automation controller). For example, consider that switches may have limited traffic capacity. Simple Network Management Protocol (SNMP) can be used for utilization monitoring. One test might only involve communication with network controls provided by Plume Design, Inc., Palo Alto, CA, USA, using limited bandwidth, while a speed test might use a large amount of bandwidth. A check could be done every 5-15 seconds and a test could be paused until adequate bandwidth was available. In one or more embodiments, a goal of dynamic resource adjustment is to deny resources to a test until the usage of those resources would not impact other existing tests. Generally, resource exhaustion, particularly network exhaustion and memory and CPU of shared compute resources, will result in all tests failing where they should not. That is to say, if the test system is overloaded, the tests will fail even though they would have passed if adequate resources were present, thus giving a false failure. Accordingly, to reduce or eliminate such false failures, one or more embodiments employ dynamic resource adjustment.

Given the discussion thus far, it will be appreciated that, in general terms, an exemplary computer-implemented method, according to an aspect of the invention, includes the step of, with a test queue analysis module 4012, accessing a test queue 4016 to identify a first test pertaining to at least one of hardware, software, and firmware (refer, for example, to the YES branch of decision block 4203). A further step includes, with the test queue analysis module, determining that it would be inappropriate to run the first test on an existing test environment. Refer, for example, to the NO branch of decision block 4209 (test cannot run on existing environment) or YES branch of decision block 4217 (test can run on existing environment but reuse would result in unacceptable delay). Still a further step includes, with the test queue analysis module, responsive to the determination of inappropriateness, checking with a hardware resource mapping module 4008 to determine that resources are available to build a new test environment for the first test. Refer, for example, to block 4211 and decision block 4213. An even further step includes, with the test queue analysis module, responsive to the determination that the resources are available, assigning a unique test environment ID and causing the hardware resource mapping module to commence instantiation of the new test environment for the first test. Refer, for example, to block 4221.

Some instances further include, with the test queue analysis module, accessing the test queue to identify a second test pertaining to at least one of hardware, software, and firmware (refer, for example, to a repetition of the YES branch of decision block 4203). Note that the at least one of hardware, software, and firmware to which the second test pertains can generally be the same as the at least one of hardware, software, and firmware to which the first test pertains, different than the at least one of hardware, software, and firmware to which the first test pertains, or partially the same as and partially different from the at least one of hardware, software, and firmware to which the first test pertains. A further step includes, with the test queue analysis module, determining that it would be appropriate to run the second test on an existing test environment. For example, decision block 4209 yields a YES and decision block 4217 yields a NO. An even further step includes, with the test queue analysis module, responsive to the determination that it would be appropriate to run the second test on an existing test environment, assigning the second test to the existing test environment (see, e.g., block 4219.

In one or more embodiments, tests, such as the first and second tests, are prioritized based on at least one of frequency, weight, and whether destructive. Refer, for example, to decision block 4225, block 4227, block 4229, and block 4231.

One or more embodiments further include using a test queue build module 4024 to place tests from a test database 4028 into the test queue 4016 based on a preconfigured limit.

In some instances, in the checking to determine that resources are available, the resources include at least one of bare hardware resources and virtualized hardware resources. For example, regarding virtualized hardware resources, this can be appropriate where physical resources are inadequate. Generally, aspects of the invention can be used to test hardware, software, firmware, virtualized hardware, combinations thereof, and the like.

One or more embodiments further include carrying out at least the first and second tests respectively using the new test environment and the existing test environment in accordance with the prioritization.

Some instances further include periodically reviewing a plurality of test environments including the new test environment and the existing test environment to assign one or more test environments of the plurality of test environments for destruction based on non-use. Refer, for example, to decision block 4233 and blocks 4237 and 4235.

As noted, in some cases, a further step includes pre-provisioning at least one commonly used test environment. Generally, such a pre-provisioned commonly used test environment could be the existing test environment, the new test environment, and/or another test environment. Furthermore, after running the system for a while, it will be possible (for example, using the HRM 4008) to identify common groupings of equipment requested by the front end. A non-limiting example of a rare combination would be a cable modem, a router behind the cable modem, two virtual machines, a Docker® container, and a Wi-Fi router. Such a rare combination would likely not be prepared in advance. On the other hand, a non-limiting example of a common combination would be a cable modem and a router, with possibly one Docker® container behind to monitor the router. A “stack” of common environments could be prepared in advance. In this aspect, when the TQAM checks the HRM for the environment at 4211 and instructs the HRM to build it at 4221, the HRM quickly responds “done” because the environment was prepared already. This aspect expedites testing by discovering the most-used environments and pre-instantiating them. Creating a new test environment could accordingly, in some instances, simply involve “spinning up” a pre-provisioned common test environment.

The first and second tests can be carried out in parallel in some cases; generally, tests can be carried out in parallel, serially, or a combination thereof.

Various practical applications of the tests are possible. For example, where at least one of the first and second tests is successful, a further step includes field-deploying actual components corresponding to the at least one of the first and second tests is successful. In another aspect, where at least one of the first and second tests is unsuccessful, further steps include corresponding redesign and retest until success is achieved, and field-deploying actual components corresponding to the successful retest. In still another aspect, where at least one of the first and second tests simulates actual field components that are failing at an unacceptable rate, further steps include corresponding redesign and retest until success is achieved, and field-deploying updated actual components corresponding to the successful retest.

In another aspect, a non-transitory computer readable medium includes computer executable instructions which when executed by a computer cause the computer to perform a method including any one, some, or all of the method steps disclosed herein, as well as steps of instantiating a test queue analysis module; instantiating a test queue build module; and/or instantiating any one, some, or all of the modules disclosed herein.

In still another aspect, an apparatus includes a memory 730; and at least one processor 720, coupled to the memory, and operative to instantiate a test queue analysis module; with the test queue analysis module, access a test queue to identify a first test pertaining to at least one of hardware, software, and firmware; with the test queue analysis module, determine that it would be inappropriate to run the first test on an existing test environment; with the test queue analysis module, responsive to the determination of inappropriateness, check with a hardware resource mapping module to determine that resources are available to build a new test environment for the first test; and, with the test queue analysis module, responsive to the determination that the resources are available, assign a unique test environment ID and causing the hardware resource mapping module to commence instantiation of the new test environment for the first test.

In some instances, the at least one processor is further operative to: with the test queue analysis module, access the test queue to identify a second test pertaining to at least one of hardware, software, and firmware; with the test queue analysis module, determine that it would be appropriate to run the second test on an existing test environment; and, with the test queue analysis module, responsive to the determination that it would be appropriate to run the second test on an existing test environment, assign the second test to the existing test environment.

In some instances, the at least one processor is further operative to prioritize at least the first and second tests based on at least one of frequency, weight, and whether destructive.

In some cases, the at least one processor is further operative to: instantiate a test queue build module; and use the test queue build module to place tests from a test database into the test queue based on a preconfigured limit.

In a further aspect, an exemplary system includes a test queue 4016; a hardware resource mapping module 4008; and a test queue analysis module (TQAM) 4012 coupled to the test queue and the hardware resource mapping module. The TQAM is configured to: access the test queue to identify a first test pertaining to at least one of hardware, software, and firmware; determine that it would be inappropriate to run the first test on an existing test environment; responsive to the determination of inappropriateness, check with the hardware resource mapping module to determine that resources are available to build a new test environment for the first test; and, responsive to the determination that the resources are available, assign a unique test environment ID and cause the hardware resource mapping module to commence instantiation of the new test environment for the first test.

In some cases, the TQAM is further configured to: access the test queue to identify a second test pertaining to at least one of hardware, software, and firmware; determine that it would be appropriate to run the second test on an existing test environment; and responsive to the determination that it would be appropriate to run the second test on an existing test environment, assign the second test to the existing test environment.

Some embodiments further include a test queue build module 4024 coupled to the test queue and configured to prioritize at least the first and second tests based on at least one of frequency, weight, and whether destructive.

Some embodiments further include a test database 4028, where the test queue build module is configured to place tests from the test database into the test queue based on a preconfigured limit.

### System and Article of Manufacture Details

The invention can employ hardware aspects or a combination of hardware and software aspects. Software includes but is not limited to firmware, resident software, microcode, etc. One or more embodiments of the invention or elements thereof can be implemented in the form of an article of manufacture including a machine-readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a tangible computer-readable recordable storage medium (or multiple such media). Appropriate interconnections via bus, network, and the like can also be included.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

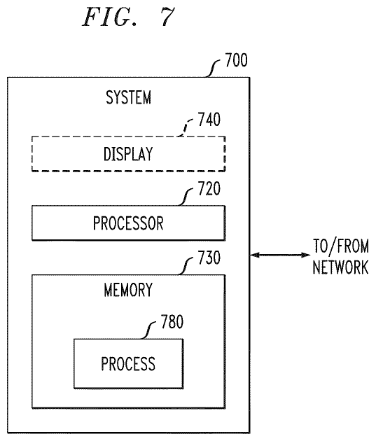

FIG. 7 is a block diagram of at least a portion of an exemplary system 700 that can be configured to implement at least some aspects of the invention, and is representative, for example, of one or more of the apparatuses, servers, or modules shown in the figures. As shown in FIG. 7, memory 730 configures the processor 720 to implement one or more methods, steps, and functions (collectively, shown as process 780 in FIG. 7). The memory 730 could be distributed or local and the processor 720 could be distributed or singular. Different steps could be carried out by different processors, either concurrently (i.e., in parallel) or sequentially (i.e., in series).

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an application-specific integrated circuit (ASIC) or field-programmable gate array (FPGA) rather than using firmware. Display 740 is representative of a variety of possible input/output devices (e.g., keyboards, mice, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, and that such program may be embodied on a tangible computer readable recordable storage medium. As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Furthermore, it should be noted that any of the methods described herein can include an additional step of providing a system comprising distinct software modules or components embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A computer-implemented method comprising:
with a test queue analysis module, accessing a test queue to identify a first test pertaining to at least one of hardware, software, and firmware;
with the test queue analysis module, determining that it would be inappropriate to run the first test on an existing test environment;
with the test queue analysis module, responsive to the determination of inappropriateness, checking with a hardware resource mapping module to determine that resources are available to build a new test environment for the first test; and
with the test queue analysis module, responsive to the determination that the resources are available, assigning a unique test environment ID and causing the hardware resource mapping module to commence instantiation of the new test environment for the first test.

2. The computer-implemented method of claim 1, further comprising:
with the test queue analysis module, accessing the test queue to identify a second test pertaining to at least one of hardware, software, and firmware;
with the test queue analysis module, determining that it would be appropriate to run the second test on an existing test environment; and
with the test queue analysis module, responsive to the determination that it would be appropriate to run the second test on an existing test environment, assigning the second test to the existing test environment.

3. The computer-implemented method of claim 2, further comprising prioritizing at least the first and second tests based on at least one of frequency, weight, and whether destructive.

4. The computer-implemented method of claim 3, further comprising using a test queue build module to place tests from a test database into the test queue based on a preconfigured limit.

5. The computer-implemented method of claim 4, wherein, in the checking to determine that resources are available, the resources include at least one of bare hardware resources and virtualized hardware resources.

6. The computer-implemented method of claim 3, further comprising carrying out at least the first and second tests respectively using the new test environment and the existing test environment in accordance with the prioritization.

7. The computer-implemented method of claim 3, further comprising periodically reviewing a plurality of test environments including the new test environment and the existing test environment to assign one or more test environments of the plurality of test environments for destruction based on non-use.

8. The computer-implemented method of claim 3, further comprising pre-provisioning at least one commonly used test environment.

9. The method of claim 3, wherein the first and second tests are carried out in parallel.

10. The method of claim 3, wherein at least one of the first and second tests is successful, further comprising field-deploying actual components corresponding to the at least one of the first and second tests is successful.

11. The method of claim 3, wherein at least one of the first and second tests is unsuccessful, further comprising corresponding redesign and retest until success is achieved, and field-deploying actual components corresponding to the successful retest.

12. The method of claim 3, wherein at least one of the first and second tests simulates actual field components that are failing at an unacceptable rate, further comprising corresponding redesign and retest until success is achieved, and field-deploying updated actual components corresponding to the successful retest.

13. A non-transitory computer readable medium comprising computer executable instructions which when executed by a computer cause the computer to perform a method comprising the steps of:
instantiating a test queue analysis module;
with the test queue analysis module, accessing a test queue to identify a first test pertaining to at least one of hardware, software, and firmware;
with the test queue analysis module, determining that it would be inappropriate to run the first test on an existing test environment;
with the test queue analysis module, responsive to the determination of inappropriateness, checking with a hardware resource mapping module to determine that resources are available to build a new test environment for the first test; and
with the test queue analysis module, responsive to the determination that the resources are available, assigning a unique test environment ID and causing the hardware resource mapping module to commence instantiation of the new test environment for the first test.

14. The non-transitory computer readable medium of claim 13, further comprising computer executable instructions which when executed by the computer cause the computer to perform additional steps including:
with the test queue analysis module, accessing the test queue to identify a second test pertaining to at least one of hardware, software, and firmware;
with the test queue analysis module, determining that it would be appropriate to run the second test on an existing test environment; and
with the test queue analysis module, responsive to the determination that it would be appropriate to run the second test on an existing test environment, assigning the second test to the existing test environment.

15. The non-transitory computer readable medium of claim 14, further comprising computer executable instructions which when executed by the computer cause the computer to perform an additional step including prioritizing at least the first and second tests based on at least one of frequency, weight, and whether destructive.

16. The non-transitory computer readable medium of claim 15, further comprising computer executable instructions which when executed by the computer cause the computer to perform additional steps including:
instantiating a test queue build module; and
using the test queue build module to place tests from a test database into the test queue based on a preconfigured limit.

17. An apparatus comprising:
a memory; and
at least one processor, coupled to the memory, and operative to:
instantiate a test queue analysis module;
with the test queue analysis module, access a test queue to identify a first test pertaining to at least one of hardware, software, and firmware;
with the test queue analysis module, determine that it would be inappropriate to run the first test on an existing test environment;
with the test queue analysis module, responsive to the determination of inappropriateness, check with a hardware resource mapping module to determine that resources are available to build a new test environment for the first test; and
with the test queue analysis module, responsive to the determination that the resources are available, assign a unique test environment ID and causing the hardware resource mapping module to commence instantiation of the new test environment for the first test.

18. The apparatus of claim 17, wherein the at least one processor is further operative to:
with the test queue analysis module, access the test queue to identify a second test pertaining to at least one of hardware, software, and firmware;
with the test queue analysis module, determine that it would be appropriate to run the second test on an existing test environment; and
with the test queue analysis module, responsive to the determination that it would be appropriate to run the second test on an existing test environment, assign the second test to the existing test environment.

19. The apparatus of claim 18, wherein the at least one processor is further operative to prioritize at least the first and second tests based on at least one of frequency, weight, and whether destructive.

20. The apparatus of claim 19, wherein the at least one processor is further operative to:
instantiate a test queue build module; and
use the test queue build module to place tests from a test database into the test queue based on a preconfigured limit.

21. A system comprising:
a test queue;
a hardware resource mapping module; and
a test queue analysis module coupled to the test queue and the hardware resource mapping module and configured to:
access the test queue to identify a first test pertaining to at least one of hardware, software, and firmware;
determine that it would be inappropriate to run the first test on an existing test environment;
responsive to the determination of inappropriateness, check with the hardware resource mapping module to determine that resources are available to build a new test environment for the first test; and
responsive to the determination that the resources are available, assign a unique test environment ID and cause the hardware resource mapping module to commence instantiation of the new test environment for the first test.

22. The system of claim 21, wherein the test queue analysis module is further configured to:
access the test queue to identify a second test pertaining to at least one of hardware, software, and firmware;
determine that it would be appropriate to run the second test on an existing test environment; and
responsive to the determination that it would be appropriate to run the second test on an existing test environment, assign the second test to the existing test environment.

23. The system of claim 22, further comprising a test queue build module coupled to the test queue and configured to prioritize at least the first and second tests based on at least one of frequency, weight, and whether destructive.

24. The system of claim 23, further comprising a test database, wherein the test queue build module is configured to place tests from the test database into the test queue based on a preconfigured limit.
